(19) United States
(12) Patent Application Publication
(10) Pub. No.: US 2025/0033496 A1
(43) Pub. Date: Jan. 30, 2025

(54) PRESSURE-SENSING CHARGE HANDLE FOR ELECTRIC VEHICLE

(71) Applicant: Joby Aero, Inc., Santa Cruz, CA (US)

(72) Inventors: Robert Wilson Rowland, San Francisco, CA (US); Edward Thomas Sweet, Burlingame, CA (US)

(21) Appl. No.: 18/917,908

(22) Filed: Oct. 16, 2024

Related U.S. Application Data
(63) Continuation of application No. 18/458,058, filed on Aug. 29, 2023.
(60) Provisional application No. 63/374,233, filed on Aug. 31, 2022.

(51) Int. Cl. B60L 53/16; B60L 53/66; B60L 58/26; H02J 7/00

(52) U.S. Cl. CPC B60L 53/16; B60L 53/66; B60L 58/26; H02J 7/0042; B60L 2200/10

(57) ABSTRACT

Examples relate to a charge handle for an electric aircraft. The charge handle can include a housing and a core slidably accommodated within the housing. A coolant flow path can be within the core, and a plurality of pressure sensors can be located within the core to detect pressure within the coolant flow path. A communication interface can transmit pressure data from the pressure sensors, enabling control of coolant flow based on the transmitted data. The plurality of pressure sensors can include at least two sensors. The coolant flow path can include a coolant in chamber and a coolant out chamber, with a first pressure sensor detecting pressure in the coolant in chamber and a second pressure sensor detecting pressure in the coolant out chamber.

### CLAIM FOR PRIORITY

The present application is a continuation of U.S. patent application Ser. No. 18/458,058, filed Aug. 29, 2023, which claims priority to U.S. Provisional Patent Application No. 63/374,233, filed on Aug. 31, 2022, the contents of each of which are incorporated herein in their entirety.

### BACKGROUND

Electric vehicles use battery power to enable vehicle functions, such as propulsion and support systems. Modern battery technology requires careful thermal management during conditioning, charging, and discharging to achieve improved battery performance. Inadequate thermal management of the battery can endanger the vehicle, its occupants, bystanders, and/or the surrounding environment.

In addition, it is advantageous to charge the battery quickly and efficiently, which must be balanced against the heat generated within the battery by such charging processes. These challenges are compounded in contexts where the electric vehicle system includes relatively large batteries, and the design is subject to stringent constraints on weight, complexity, and/or safety, such as aviation.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a diagrammatic representation of an electric aircraft charging environment, according to some examples, showing an aircraft that is coupled to ground support equipment for charging or discharging.

FIG. 2 is a block diagram that provides a different view of the example electric aircraft charging environment shown in FIG. 1.

FIG. 3 is a block diagram that provides a further view of the electric aircraft charging environment, according to some examples.

FIG. 4 is a cross-sectional view of the hose and cable bundle, according to some examples.

FIG. 5 is a perspective view of a charge handle, according to some examples.

FIG. 6 is a further perspective view of a charge handle, according to some examples.

FIG. 7 illustrates an exploded view of a charge handle, according to some examples.

FIG. 8 is a cross-sectional side view of the charge handle, according to some examples.

FIG. 9 is a cross-sectional side view of the charge handle, according to some examples.

FIG. 10 shows a cross-sectional front view of the charge handle, according to some examples.

FIG. 11 is a cross-sectional view of the charge handle, according to some examples, illustrating details of a core and a cam drive mechanism to move the core between the engaged and disengaged positions.

FIG. 12 includes a sequence of perspective views of the charge handle, according to some examples, showing the driving of the core within the housing, from the engaged position to the neutral position, and then to the disengaged position.

FIG. 13, as with FIG. 12, includes a sequence of perspective views of the charge handle, according to some examples, showing the driving of the core within the housing, from a disengaged position to a neutral position, and then to an engaged position.

FIG. 14 is a perspective view of the charge handle, according to some examples, showing a latching mechanism that seeks to prevent an accidental disconnect of the charge handle from a charge port of the aircraft.

FIG. 15 is a cross-sectional view of the core, according to some examples, and shows the position and functioning of a recirculation valve.

FIG. 16 is a diagrammatic representation of an interface of an aircraft, according to some examples, and connections between the aircraft and the ground support equipment that may be facilitated via the interface of a single charge port.

FIG. 17 is a flowchart illustrating operations, according to some examples, performed by the ground support equipment in order to ready an aircraft for a flight.

FIG. 18A and FIG. 18B show a flowchart depicting a method, according to some examples, to charge and condition an electric aircraft for a flight.

FIG. 19 is a flowchart illustrating a method, according to some examples, of engaging the charge handle with a charge port 106 of an electric vehicle.

FIG. 20 is a flowchart illustrating a method, according to some examples, for engagement of a charge handle, as described above, with a charge port of an electric vehicle.

FIG. 21 is a flowchart illustrating a method, according to some examples, of operating ground support equipment with respect to an electric vehicle.

FIG. 22 is a flowchart illustrating a method, according to some examples, to operate a charging station.

FIG. 23 is a flowchart illustrating a method, according to some examples, to operate a charging station having multiple power supplies.

FIG. 24 is a plan view of an aircraft, according to some examples.

FIG. 25 is a schematic view of an aircraft energy storage system, according to some examples.

FIG. 26 illustrates an electrical architecture for the aircraft, according to some examples.

FIG. 27 illustrates a computing environment associated with an aviation transport network according to some examples.

FIG. 28 illustrates a diagrammatic representation of a machine in the form of a computer system within which a set of instructions may be executed for causing the machine to perform any one or more of the methodologies discussed herein, according to some examples.

### DETAILED DESCRIPTION

### Introduction

Electric vehicles use rechargeable battery systems to power propulsion and vehicle systems. Effective management of these battery systems during charging and discharging seeks to ensure safe, efficient, and reliable operation of electric vehicles. The high energy densities and complex thermal behaviors of modern battery chemistries present challenges in maintaining battery temperatures within an optimal range, balancing cell voltages, and avoiding undesired thermal events.

While the examples described herein focus on a specific type of electric vehicle, namely an electric vertical take-off and landing (eVTOL) aircraft, the systems and methods prescribed may more broadly apply to any electric vehicle employing rechargeable batteries. eVTOL aircraft have additional design constraints compared to ground vehicles that may further complicate battery system management. Limited space and stringent safety requirements demand a high level of monitoring and control over battery charging and health.

The following description details example systems and methods for managing the battery systems of an all-electric eVTOL aircraft during ground charging operations. The aircraft may include a lithium-ion battery system comprising multiple battery modules or packs, and a dedicated battery management system. A ground charging station provides the electrical power and control systems to recharge the aircraft batteries. The ground charging station monitors key parameters of the battery system including temperatures, individual cell voltages, and pack voltages to ensure safe charging within specified limits. It also logs details of each charging session to provide a service and maintenance history for the battery system.

Communication between the aircraft, charge handles, a ground charging station, and a battery management system enables coordinated control over the charging process. The example systems use various interfaces to transmit data and commands, monitor the battery system throughout charging and ensure it remains within safe operating ranges as defined for the specific battery chemistry and vehicle design. The integrated control and monitoring systems described provide a robust solution for managing battery health and enabling fast, efficient charging of electric vehicles, like the eVTOL aircraft.

Further, and as noted above, eVTOL aircraft may require specialized ground support equipment to charge and condition their batteries before flight. Charging aircraft batteries may present several technical challenges, including the large amounts of power required, the heat generated during fast charging, a need to charge multiple isolated battery packs, and security and safety risks. Existing solutions have not adequately addressed these challenges for electric vehicles generally.

Further, aircraft batteries are typically high-energy lithium-ion packs that require high-voltage, high-current charging equipment to fully charge in a reasonable time. The large power levels required for fast-charging aircraft batteries can overload standard electrical infrastructure and require specialized ground support equipment. The high currents also generate significant heat within the batteries during charging, which needs to be dissipated to prevent overheating.

Vehicles may also have separate isolated battery packs to provide redundancy, requiring multiple independent charging circuits and thermal management systems. For example, electric vertical take-off and landing (eVTOL) aircraft benefit from redundant and isolated propulsion and energy storage systems to ensure safe operations in the event of any single system failure. The use of multiple independent, isolated battery packs provides redundancy to power independent propulsion systems.

Each battery pack (or module) may be sized to independently power one or multiple propulsion systems and critical aircraft loads in case any other battery pack fails. Independent battery management systems for each battery pack help ensure balanced charging and discharging across multiple isolated battery packs during normal operation. In the event any single battery pack fails or is depleted, the remaining battery packs can continue providing power to propulsion and critical systems for a controlled landing. The battery packs may be physically isolated from each other, with no or few shared components that could allow issues with one pack to impact others. Each pack's wiring, power electronics, cooling systems, and other components may be separate.

Described examples include a multi-channel charging system with separate, isolated channels for each battery pack that enable redundant charging capabilities. Each charging channel can operate independently to charge an associated battery pack as needed based on the battery pack's state of charge, temperature, and other parameters. If any single charging channel fails or is compromised, the remaining channels can continue charging the other battery packs normally.

The redundancy and isolation provided by independent battery packs and charging systems seek to enhance the safe operation of aircraft by ensuring that no single point of failure in the energy storage or propulsion systems can result in a loss of power or unsafe operating conditions.

Safety is also a paramount concern when charging aircraft due to the potential hazards from high voltage, high current, and battery thermal runaway. Existing charging equipment may not provide adequate safeguards and redundancies to address these risks. Described examples enable sequenced connections for power, data, and cooling with lockout mechanisms to prevent accidental disconnection under load and ensure proper engagement before energizing the system. Integrated cooling systems are also helpful in preventing overheating at high charge rates.

As noted above, electric aircraft may require high-power, fast-charging battery systems to enable efficient operations. However, the battery packs' high charge and discharge rates also generate significant amounts of heat that may need to be adequately dissipated to ensure safe and efficient charging. Without adequate thermal management during charging, battery temperatures can rise to unsafe levels, reducing performance, accelerating degradation, and potentially resulting in thermal runaway.

Ground-based cooling systems may supplement aircraft on-board thermal management during charging when heat generation rates are highest. In some examples, a chiller is employed to actively cool a heat transfer fluid (or coolant), which is then circulated through the battery packs of the aircraft during charging. The cooling system is designed to dissipate heat generated by the battery packs during conditioning and supported charging rates, and is capable of maintaining safe temperature levels in multiple battery packs throughout charging.

Before the start of charging, the ground cooling system may condition battery packs by pre-cooling the battery packs to within a determined temperature range for a charging rate to be used. The ground cooling system then continues circulating cooled fluid through the battery packs of the aircraft throughout the charging process to dissipate heat as it is generated. Fluid flow rates and temperatures are actively controlled for each pack based on its temperature and state of charge to the heat removal rate. Heated fluid from the aircraft is cooled and recirculated.

Turning to security within the context of ground-based support equipment, data connections, data connections between charging systems and aircraft may present cybersecurity risks. During charging, connections between aircraft data networks and ground charging equipment are established for functions such as sending charge control commands, monitoring battery state of charge and health, and downloading flight data. These connections represent potential vulnerabilities where malicious actors could gain unauthorized access to aircraft systems if charging data networks are not adequately secured. Various security measures are described below that seek to address these security concerns,

### Ground Support Equipment (GSE)/Charging Station

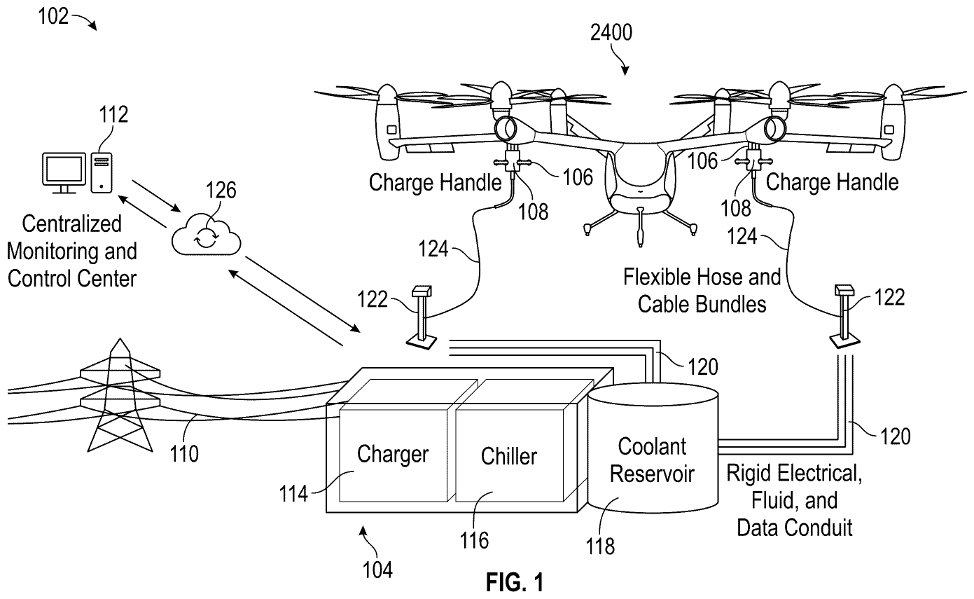

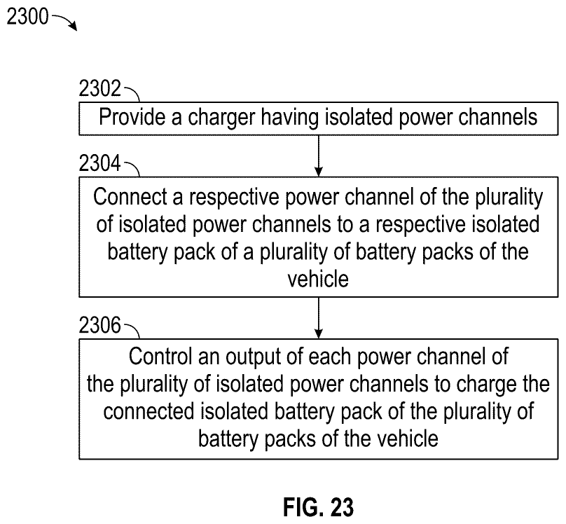

FIG. 1 is a diagrammatic representation of an electric aircraft charging environment 102, according to some examples, comprising an electrically powered vehicle in the form of an aircraft 2400 that is coupled for charging from or discharging to electric vehicle supply equipment (EVSE) in the form of ground support equipment 104. The aircraft 2400 may, in some examples, be an eVTOL (electric vertical takeoff and landing) aircraft 2400 for which further details are provided in FIG. 24. The aircraft 2400 is equipped with one, two or more charge ports 106 to facilitate charge and discharge of any number of battery packs 2502 of the aircraft 2400. For example, a single charge port might be used to charge two, three, four or even more isolated battery packs. The charge ports 106 on the aircraft 2400 allow it to connect via charge handles 108 to the ground support equipment 104 for conditioning/charging/discharging and cooling its batteries. Liquid cooling is integrated into both the charge ports 106 and the charge handles 108 to speed up the charging and discharging process so the aircraft 2400 can complete more flights.

The charge handles 108 serve as the interface between the ground support equipment 104 and the aircraft 2400. The charge handles 108 contain connectors to mate with the charge ports 106 on the aircraft 2400, providing the DC power, coolant loop, and data connections. The charge handles 108 contain an interlock to ensure proper connection before energizing the DC power or coolant. The interlock functionally ensures that a charge handle 108 is not removed or tampered with while the ground support equipment 104 is still actively supplying electricity, thereby avoiding potential electrical hazards or injuries. Example interlock mechanisms may be electromechanical or electronic in nature.

A coolant (e.g., a coolant fluid) is shared between a charge handle 108 and the aircraft 2400, in contrast to merely using the coolant to cool a charge handle 108 during a charging operation. This sharing of coolant fluid may be particularly beneficial in that it enables a reduction of the amount of coolant carried internally and stored within the aircraft 2400. Coolant sharing may enable sufficient cooling of battery packs (e.g., battery packs 1602/battery packs 2502) during a fast charging session, for example, immediately before takeoff. This may then provide a benefit in that it enables a quick turnaround between landing, recharging, and takeoff of an aircraft 2400. A further potential benefit is that the internal cooling system of the electric aircraft 2400 may be smaller in size and accordingly, in conjunction with the reduced amount of coolant that would otherwise be to be carried by an electric aircraft 2400, is effective in reducing the overall weight of the electric aircraft 2400. Thus, the ground support equipment 104 provides a coolant loop through the charge handles 108, which connects to the internal cooling system of the aircraft 2400. Sharing the coolant between the ground support equipment 104 and the aircraft 2400 reduces the amount of coolant the aircraft 2400 needs to carry, allowing for a smaller internal cooling system and lower overall weight. This also speeds up the turnaround time between landing, charging, and takeoff.

In order to allow the aircraft to go through a full flight profile without overheating, the battery packs 2502 of the aircraft 2400 may be cold soaked before takeoff, and towards the end of a charging cycle. The cold soaking process seeks to cool the battery packs 2502 to an ambient temperature. The aircraft 2400 then takes off and uses the coolant fluid as a thermal mass to sink heat into, through flow of the coolant fluid.

The ground support equipment 104 is electrically coupled by a grid connection 110 to electrical power grid, and is communicatively coupled, via a communications network 126, to a control center 112 that provides centralized monitoring and control of the ground support equipment 104. The control center 112 coordinates charging operations for multiple aircraft at a time and ensures safe functioning of ground support equipment 104. Operators at the control center 112 work with pilots and ground crew to initiate and monitor the charging process for each aircraft.

The ground support equipment 104 includes a charger 114, a chiller 116, and a coolant reservoir 118 that are coupled by respective conduits (e.g., electrical conduits, fluid conduits, and data conduits) of a master conduit 120 to one or more dispenser 122. The dispensers 122 are each coupled by a hose and cable bundle 124 to a charge handle 108 that operatively mates with a charge port 106 of the aircraft 2400. The charger 114, as will be described in further detail below, receives electrical charge via the grid connection 110, stores electrical charge, and then distributes the charge via electrical conduits to the charge handles 108 to charge battery packs 2602 packs 3002 of the aircraft 2400. The chiller 116 chills coolant fluid stored within the coolant reservoir 118, before the coolant fluid is supplied via fluid conduits to the charge handles 108 and then into the internal fluid circulation systems 2504 of the aircraft 2400, whereafter the circulated coolant fluid is then returned to the coolant reservoir 118 for chilling by the chiller 116. In this way, a fluid circulation pathway is defined between the ground support equipment 104 and the aircraft 2400, whereby chilled coolant fluid is provided from the ground support equipment 104 to the aircraft 2400, and warmed coolant fluid is returned from the aircraft 2400 to the ground support equipment 104. In some examples, the chiller 116 can chill the coolant to as low as −10° C. The coolant, e.g., a solution of water and ethylene-glycol, may be pumped from the coolant reservoir 118 to the charge handles 108 at a rate of up to 45 lpm per charge handle. The coolant flows into the internal cooling system of the aircraft 2400 and returns to the coolant reservoir 118, where it is re-chilled. This shared coolant loop enables quick charging turnaround times and a smaller internal cooling system on the aircraft 2400.

The charger 114 receives electrical charge via the grid connection 110, stores electrical charge, and then distributes the charge via electrical conduits to the charge handles 108 to charge battery packs 3002 of the aircraft 2400. In some examples, the charger 114 may comprise a multi-channel AC-DC charging system capable of delivering up to 400 kW total power, with each channel delivering up to 100 kW. However, the charger 114 may be configured with different numbers of channels, power levels, and voltage ranges depending on the application. For example, the charger 114 may have two, six, or eight channels, each capable of 50 kW, 150 kW, or other power levels. The charger 114 may operate from common three-phase AC input voltages like 480V, or a wide range of AC or DC input voltages. The AC input power may come directly from the grid or from an intermediate DC power source like a stationary battery bank. Each channel of the charger 114 connects to one or more of the battery packs 3002 on the aircraft 2900 through the charge ports 106, and charge handles 108. The total power output can be distributed across the channels as needed to charge each battery pack 3002 based on its state of charge, chemistry, and charging profile. The flexible and modular architecture of the charger 114 enables it to be configured for different aircraft battery configurations and optimized for the specific charging application.

Power delivery to each channel may also be modulated to implement load balancing strategies and optimize battery health. An interposer translates the specific charging requirements of each battery pack to control the voltage and current output for that channel. The interposer and power channels are designed to accommodate the high-rate charging needs of the battery packs while maintaining electrical isolation between packs for safety and reliability.

The master conduit 120 contains the electrical, coolant, and data conduits that provide connections between the ground support equipment 104 components and the charging dispensers 122. The hose and cable bundles 124 extend these connections to the charge handles 108. The dispensers 122 provide structural support for the hose and cable bundles 124 and an interface for the ground crew to handle and maneuver the charge handles 108.

A more detailed description of the ground support equipment 104, construction of the conduits 120, the hose and cable bundles 124, and the charge handles 108 is provided herein, along with a description of the relevant control protocols and sequences for operations performed using this equipment within the electric aircraft charging environment 102.

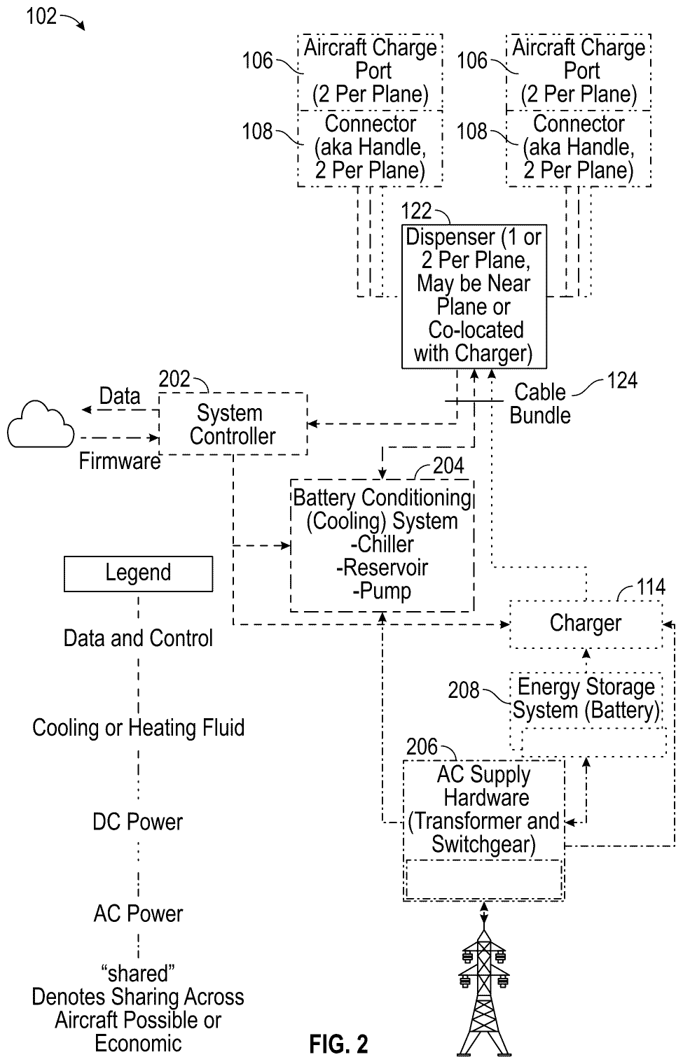

FIG. 2 is a block diagram that provides a different view of the example electric aircraft charging environment 102 shown in FIG. 1.

Additional detail shown in FIG. 2 includes a system controller 202, which may be integrated within a dispenser 122. The system controller 202 receives firmware (e.g., new installs and updates) from the control center 112 for provisioning to the aircraft 2400, and which provides data (e.g., telemetry data) from the charge handles 108 and the aircraft 2400 to the control center 112.

The chiller 116, coolant reservoir 118, and a pump 302 are shown to form part of a battery conditioning system 204, which is also coupled to the system controller 202.

One or more dispensers 122 are coupled between the system controller 202, battery conditioning system 204, and the charge handles 108. Each dispenser 122 may control the flow of power and coolant between the charger 114 and the aircraft 2400. A dispenser 122 receives one-way commands from the aircraft's battery management system via Ethernet to direct the charging process. Based on these commands, the dispenser 122 controls the power electronics of the charger 114 to independently charge the aircraft's four or more battery packs at desired current and voltage levels. The dispensers 122 and the charger 114 may communicate via a CAN bus to coordinate charging.

Each dispenser 122 contains a controller that includes computing hardware to interpret the commands from the aircraft 2400 and control the charger 114 accordingly. The controller monitors the status of the charging process, including current, voltage, and temperature levels for each battery pack. It can adjust or stop the charging process for a battery pack based on the aircraft's commands. The controller also monitors the status of the coolant system and pumps to ensure proper thermal conditioning of the batteries during charging.

A dispenser 122 may also have a touchscreen interface to allow ground crew to monitor the charging process and receive any alerts. The interface displays the charging status of each battery pack, including the current charge level, time remaining to full charge, temperature, current, and voltage. The interface allows the ground crew to make any necessary adjustments to the charging process to ensure safe and efficient operation.

A dispenser 122 contains electronically controlled pumps and valves to regulate the flow of coolant to the aircraft 2400. Based on the temperature requirements from the aircraft's battery management system, the PLC controller controls the pumps and valves to provide the necessary flow rate and volume of coolant to maintain the optimal temperature range for the batteries during charging. The coolant flow can be continuously adjusted based on the temperature readings from the batteries.

A dispenser 122 signals to the ground crew when the charging process is complete and the connector can be safely disconnected from the aircraft. A status indicator light on the dispenser 122 may illuminate when charging is finished, and the coolant lines have been flushed. The ground crew can then disengage the charge handles 108 from the aircraft's charge ports 106.

The battery conditioning system 204 and the charger 114 are coupled to AC supply hardware 206, which includes a transformer and switchgear to facilitate electrical power transmission from the grid via the grid connection 110.

An energy storage system 208, which includes multiple batteries, is coupled between the AC supply hardware 206 and the charger 114, and stores energy received from the grid via the AC supply hardware 206 within the batteries for provisioning to the charger 114. The energy storage system 208 provides backup power to the ground support equipment 104 in the event of a power outage or other disruption of the main AC power supply from the grid connection 110. The energy storage system 208 includes multiple high-energy lithium-ion battery packs connected in parallel to provide a high-current DC power source. Each battery pack (e.g., of battery packs 1602 or battery packs 2502) contains multiple lithium-ion battery modules, which in turn contain multiple lithium-ion battery cells.

The energy storage system 208 provides reliable backup power for the ground support equipment 104 in case of AC power disruption. Its robust, modular lithium-ion battery packs offer high energy density, fast recharging, and long cycle life. With its high-power output and energy capacity, the energy storage system 208 seeks to ensure that charging operations can continue even when AC power is lost, helping to minimize disruption. The energy storage system 208 enhances the reliability, safety, and efficiency of the ground support equipment 104.

Focusing now on the system controller 202, the system controller 202 may be a computer system that manages operations of the ground support equipment 104. It contains data stores with information regarding the battery packs 1602 of connected aircraft 2400, coolant energy storage system 208, charging equipment, users, maintenance records, and other aspects required to control charging and monitor the system. The system controller 202 uses this data to safely and efficiently charge connected aircraft 2400.

The system controller 202 coordinates the charging profiles for each battery pack 1602 based on their state of charge and chemistry, for example. It controls the charger 114 and pumps 302 to maintain proper temperatures and charge rates for the battery packs 1602 based on feedback from sensors. The system controller 202 can adjust or stop the charging process for a battery pack 1602 based on commands from the aircraft 2400.

The system controller 202 may receive, access, store and modify the following types of data related to the GSE (ground support equipment) and aircraft 2400:
Charge Profile Data: ⋅Battery Pack ID: Identifies the specific battery pack (1-4) ⋅Battery Chemistry: Chemistry of the battery cells (e.g., Li-ion, Li-sulfur) ⋅Charge Rate: Maximum charge rate of the battery pack (e.g., 1C, 2C) ⋅Target Voltage: Voltage to charge the battery pack to ⋅Charge Current: Current level to charge the battery pack at based on the state of charge ⋅Termination Current: Minimum current level to end charge at ⋅Max Cell Voltage: Maximum voltage for any individual cell in the pack ⋅Max Pack Voltage: Maximum total voltage for the battery pack ⋅Max Temperature: Maximum temperature for the battery pack during charge
Coolant Data: ⋅Temperature Sensors: Locations of temperature sensors providing data ⋅Pressure Sensors: Locations of pressure sensors providing data ⋅Pump Speeds: Speed settings for coolant pumps to achieve target flow rates ⋅Valve Positions: Open/close positions for valves to control coolant flow ⋅Target Flow Rates: Desired coolant flow rates for different areas/components.
Telemetry Data: ⋅Time Stamp: Time data was received ⋅Aircraft ID: Identifier for the specific aircraft ⋅Data Type: Type of telemetry data (e.g., battery levels, motor performance, flight controls) ⋅Data Values: Telemetry data received from the aircraft.
Error Codes Data: ⋅Error ID: Unique identifier for the error ⋅Error Source: Source where the error originated (e.g., handle, pump, data link) ⋅Error Description: Description of the error that occurred ⋅Resolution: Steps required to resolve the error ⋅Notes: Any additional notes on the error.
Access Log Data: ⋅Time Stamp: Time of access ⋅User ID: Identifier of the user accessing the system ⋅Access Type: Type of access (e.g., login, logout, remote access) ⋅Notes: Any additional notes on the access event.
Aircraft Data: ⋅Information on the specific aircraft being charged including aircraft ID, battery pack configurations, maximum charge rates, etc.
User Accounts Data: ⋅Information on authorized users of the GSE system including username, password, access level, contact information, etc.
Equipment Maintenance Data: ⋅Information on maintenance performed on the GSE equipment including equipment ID, maintenance type, date performed, technician, notes, etc. This table would provide a maintenance log for the system.
Calibration Data: ⋅Information from calibration of sensors and equipment in the system. This may include calibration dates, reference values, sensor offsets, etc. The data would be used to ensure accurate control and monitoring.
Charging Session Logs: ⋅Information on each charging session including aircraft ID, start/end times, kWh charged, error codes, notes, etc. This table provides historical records of each charging session for review and analysis.
Coolant System Data: ⋅Information on the coolant used in the system including coolant type, concentration, flow rates, pressures, temperatures, etc. This data would ensure the coolant system is properly operated and maintained.
Safety Mechanisms Data: ⋅Information on the safety mechanisms and interlocks in the system. This may include descriptions of the mechanisms, test records, error conditions that trigger the mechanisms, etc. The data would be used to ensure safe operation and compliance.
Site Layout Data: ⋅Information on the layout of the charging equipment at the site, including equipment locations, cable routing, access points, hazard areas, etc. This table provides an overview of the charging site setup.

The system controller 202 coordinates with the aircraft 2400 and monitors the charging process to ensure the battery packs 1602 remain within safe operating ranges based on their specific battery chemistry and vehicle design. It logs details of each charging session to provide a service and maintenance history for the battery system. The system controller 202 may also receive firmware (e.g., new installs and updates) from the control center 112 for provisioning to the aircraft 2400, and provide data (e.g., telemetry data) from the charge handles 108 and the aircraft 2400 to the control center 112.

The system controller 202 contains programming and data to safely operate the ground support equipment 104. It manages components like the charger 114, pumps 302, chillers 116, and valves based on the needs of the aircraft 2400 and feedback from sensors monitoring the system. The system controller 202 coordinates the charging process, activating equipment, adjusting parameters, logging data, and monitoring for any issues.

The system controller 202 has interfaces to allow the ground crew to monitor the charging process and receive any alerts from the system. The interfaces display the charging status of battery packs 1202, including the current charge level, time remaining to full charge, temperature, current, and voltage. The interfaces allow the ground crew to make adjustments to the charging process to ensure safe and efficient operation.

The system controller 202 also communicates with the control center 112, which coordinates charging operations for multiple aircraft at a time and ensures the safe functionality of ground support equipment 104 systems. Operators at the control center 112 work with pilots and ground crew to initiate and monitor the charging process for each aircraft 2400. The control center 112 provides centralized monitoring and control of the ground support equipment 104.

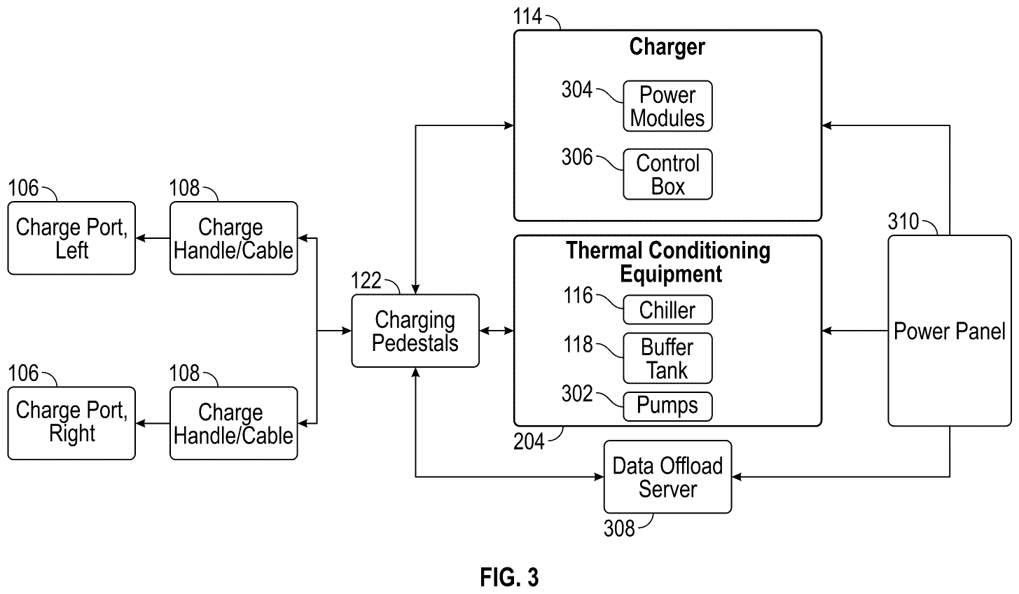

FIG. 3 is a block diagram that provides a further view of the electric aircraft charging environment 102, according to some examples.

Additional detail is shown in FIG. 3 includes powers supplies (or power modules 304) and a control box 306 that form part of the charger 114. The various components of battery conditioning system 204 (which includes thermal conditioning equipment comprising the chiller 116, the coolant reservoir 118 (or buffer tank) and pumps 302) are also shown. Further, a data offload server 308 (that forms part of the system controller 202) is shown to be coupled between a power panel 310 (that forms part of the AC supply hardware 206) and the dispensers 122. The data offload server 308 may also contain a site-level controller that is connected to the thermal conditioning equipment for the purposes of control and telemetry as well as relaying site-level instructions to the dispenser 122.

### Hose and Cable Bundle 124

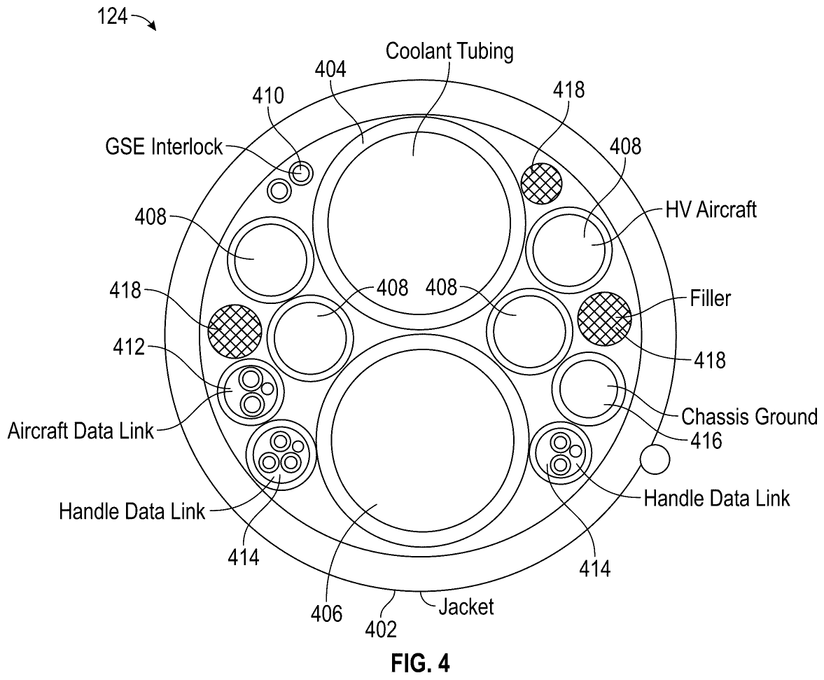

FIG. 4 is a cross-sectional view of the hose and cable bundle 124, according to some examples and as first mentioned with respect to FIG. 1.

The hose and cable bundle 124 comprises an abrasion-resistant jacket 402 that encloses a number of conductors and tubing. The jacket 402 may comprise a nylon/Kevlar blend welding cable jacket or, for example, an elastomeric polymer jacket.

Within the jacket are enclosed a pair of coolant tubes or lines including a coolant in tube 404 and a coolant out tube 406 that operate as an input line and a return line, respectively, to circulate coolant fluid to and from the aircraft 2400. Specifically, the coolant in tube 404 is in fluid communication with the coolant in connector 516 of a charge handle 108, and the coolant out tube 406 is in fluid communication with the coolant out connector 518 of a charge handle 108. Each of the coolant tubes may be constructed from a high dielectric strength rubber.

A pair of (HV) high-voltage aircraft charging conductors 408 is coupled to electrical connectors 520 of a charge handle 108 and is enclosed in a soft polymer or annealed rubber insulation. A pair of ground support equipment (GSE) interlock cables 410 couple the aircraft 2400 to the ground support equipment 104 via a charge handle 108, and comprise twisted-pair cabling.

An aircraft data link 412 is coupled to the data offload and interlock 512 of the charge handle 108, and includes two ethernet cables, a 1000BASE-T and a 100BASE-T cable. A pair of handle data links 414 provides data to control circuitry (e.g., in a PCB assembly 730) of the charge handle 108 itself, and each handle data link 414 comprises a twisted-pair equipment communication line.

A chassis ground cable 416 is coupled to the chassis ground connector 514 of a charge handle 108. Filler material 418 is used to bind the conductors and hoses within the hose and cable bundle 124 in place and to retain the relative positioning of conduits and cables.

### Charge Handles 108

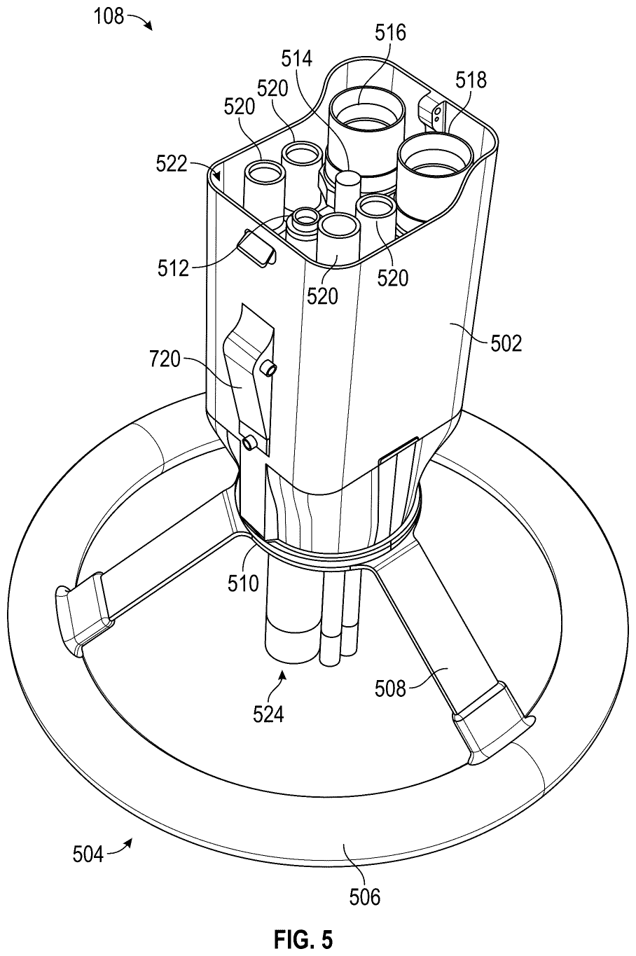

FIG. 5 is a perspective view of a charge handle 108, according to some examples.

The charge handle 108 consists of several components. These include a housing 502 (e.g., an outer shell), a core 708 (including a drive tube or piston), and a drive mechanism. The core 708 is slidably accommodated and secured within the housing 502. The drive mechanism, actuated by a wheel handle 504. The wheel handle 504 has a ring base 506, is mounted number of arms 508 that extend upwardly and inwardly from the ring base 506 to a support ring 510. The drive mechanism is secured to and mounted on the support ring 510.

The core 708 has a main body defines or contains channels or passages to accommodate wiring and tubes from the hose and cable bundle 124 that connect to various connectors of the charge handle 108. The core 708 also consists of lower housing 716 and upper housing 718, mounted above the main body where these connectors are mounted. Other components of the charge handle 108 include a latching mechanism for securing it to a vehicle body, and control and communication circuitry accommodated on a PCB assembly 730 within the core 708.

A set of connectors is secured to and extends from an upper or distal end of the core 708. The set of connectors includes fluid connectors, high-voltage electrical connectors, and a data connector. The set of connectors may facilitate a sequenced engagement and disengagement of coolant (or cooling) fluid, electrical power, and data transfer between an electric vehicle (e.g., the aircraft 2400) and charging equipment (e.g., the ground support equipment 104), as will be described in further detail, during a connection or disconnection operation.

In some examples, and as shown in FIG. 5, the fluid connectors (e.g., coolant in connector 516 and coolant out connector 518) are longer than the electrical connectors ((e.g., electrical connectors 520), and the electrical connectors are longer than the data connector (e.g., data offload and interlock 512) so as to facilitate the sequenced engagement and disengagement between the charge handle 108 and the charge port 106 of the electric aircraft 2400. In the examples, the sequenced disengagement between the charge handle 108 and a charge port 106 includes a first disengagement of the data connector, a second disengagement of the electrical connectors, and a third disengagement of the fluid connectors.

In some examples (not shown), the mating positions of the fluid connectors, the electrical connectors, and the data connector facilitate the sequenced engagement and disengagement between the charge handle and the charge port of the electric aircraft.

The charge handle 108 may also define various mating positions of the fluid connectors, the high-voltage electrical connectors, and the data connector to facilitate the sequenced engagement and disengagement between the charge handle 108 and a charge port 106 of the electric aircraft 2400.

The housing 502 has a first open end or mouth 522 through which the set of connectors are accessible and able to connect with corresponding connectors of a charge port 106 when the charge handle 108 is in an engaged (extended) position with respect to the charge port 106.

The core 708 is movable between a retracted position in which the set of connectors are retracted within the charge handle 108, and an extended position in which the set of connectors extend further out or towards the mouth 522 of the housing 502 to facilitate coupling between the charge handle 108 and a charge port 106.

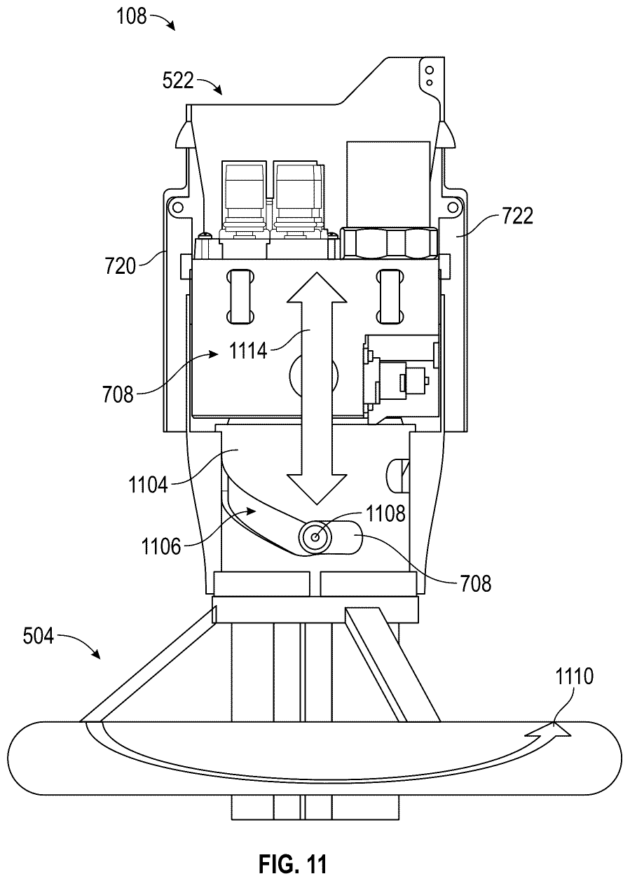

A drive mechanism is secured within the housing 502 and operationally drives the core 708 between the retracted position and the extended position. Further details of the drive mechanism are shown in and discussed herein with reference to FIG. 11-FIG. 13.

The core 710 is movable by the drive mechanism within the housing 502 between an engaged position (e.g., the extended position), a neutral position (e.g., an intermediate position), and a disengaged position (e.g., the retracted position). When in the neutral position, the connectors of the charge handle 108 are disengaged from corresponding connectors of a charge port 106. When in the disengaged position, the housing 502 is released from the electric aircraft 2400 by a latching mechanism. As noted above, the charge handle 108 includes a latching mechanism to secure the housing 502 to a charge port 106 (or some other part) of the electric aircraft 2400 during engagement of the charge handle 108 with the charge port 106. The latching mechanism operates to prevent an accidental disconnect between a charge handle 108 and a charge port 106, for example, during a charging operation. The latching mechanism, in some examples, includes a pivoting front latch arm 720 and a rear latch arm 722 that engage with corresponding structures on the interior of a charge port 106 to secure the charge handle 108 in place during engagement and neutral positions and that disengages from the corresponding structures on the interior of the charge port 106 to allow the charge handle 108 to be withdrawn from mating engagement with the charge port 106 when in a disengaged position. Further details regarding displacement and locking of the front latch arm 720 and the rear latch arm 722 are described herein with reference to other figures.

The fluid connectors, in some examples, include first and second fluid connectors in the form of a coolant in connector 516 and a coolant out connector 518. These fluid connectors operationally facilitate the provision of a chilled fluid from a fluid source external, such as the coolant reservoir 118 of the ground support equipment 104, to the electric aircraft 2400. The fluid connectors may, in some examples, each also include a dry break coupler.

A dry break coupler may allow a fluid connection to be made between the charge handle 108 and the aircraft 2400 without leaking a fluid or allowing air into the fluid circuit. The dry break coupler may consist of a cylinder with O-rings around its interior perimeter that create a seal when the male and female sides of the coupler are connected. When the male section of the dry break coupler is inserted into the female section, O-rings seal against the surfaces of the male section, allowing pressurized coolant to flow through the connection. The tight seal created by the O-rings prevents leakage of coolant or ingress of air at the connection point. When the sections are disconnected, the O-rings maintain the seal on each individual section, keeping the fluid contained.

The electrical connectors, in some examples, include first and second high-voltage electrical connectors in the form of high-voltage electrical connectors 520 (or battery connectors) and a chassis ground connector 514 to operationally facilitate conditioning, charge and discharge of respective first and second isolated battery packs 2502 of the electric aircraft 2400 from an electric source external (e.g., charger 114) of the electric aircraft 2400. The electrical connectors 414 may, in some examples, facilitate the concurrent charging or discharging of the isolated battery packs 2502.

The data connector, in some examples, comprises a data offload and interlock 512 to operationally facilitate a transfer of data between the electric aircraft 2400 and an external data system, such as the system controller 202.

As noted above, the charge handle 108 includes a latching mechanism to secure the housing 502 to a charge port 106 (or some other part) of the electric aircraft 2400 during engagement of the charge handle 108 with the charge port 106. The latching mechanism operates to prevent an accidental disconnect between a charge handle 108 and a charge port 106, for example, during a charging operation. The latching mechanism, in some examples, includes a pivoting front latch arm 720 and a rear latch arm 722 that engage with corresponding structures on the interior of a charge port 106 to secure the charge handle 108 in place during engagement and neutral positions and that disengages from the corresponding structures on the interior of the charge port 106 to allow the charge handle 108 to be withdrawn from mating engagement with the charge port 106 when in a disengaged position. Further details regarding displacement and locking of the front latch arm 720 and the rear latch arm 722 are described herein with reference to other figures.

Regarding the sequenced engagement and disengagement, and as noted above, the charge handle 108 facilitates a sequenced engagement and disengagement of the grounding, fluid, high-voltage electrical, and data connections between the charge handle 108 and aircraft charge port 106. This sequencing ensures safe connection and disconnection of the systems.

The grounding connection is engaged first by extending the chassis ground connector 514 from the charge handle 108 into the charge port 106. The chassis ground connector 514 provides a low-resistance path to ground that helps discharge any static buildup and ensures the charge handle 108 and the charge port 106 are at the same electrical potential.

Next, the example fluid connectors, coolant in connector 516 and coolant out connector 518, are engaged to form a cooling fluid circuit between the ground support equipment 104 and the aircraft 2400. The fluid connection allows cooling fluid flow before energizing the high-voltage systems. The fluid connectors are longer than the other connectors (e.g., electrical connectors 520, data offload and interlock 512, chassis ground connector 514) so they engage first as the charge handle 108 moves into the charge port 106. Check valves within the fluid connectors prevent backflow when disengaging.

The high-voltage electrical connectors 520 are then engaged to form a power connection between the charger 114 and aircraft battery packs 2502. The electrical connectors 520 have insulated sleeves to prevent arcing during connection. The power connections are made after grounding and cooling fluid flow are established for safety.

Finally, the data connector, for example the data offload and interlock 512, is engaged to enable communication between the ground support equipment 104, the charge handle 108, and the aircraft 2400. The data offload and interlock 512 provides monitoring and control of the charging process. It is the last connection made to avoid data transfer before the power systems are properly grounded and cooled.

Disengagement of the connections happens in reverse sequence: data offload and interlock 512 disconnects first, followed by the electrical connectors 520, then coolant in connector 516 and coolant out connector 518, and finally chassis ground connector 514. This systematic approach helps ensure safe connection and disconnection of the high-power systems between the ground support equipment 104 and aircraft 2400. The sequencing and physical design of the connectors mitigate risks like arcing, overheating, and static discharge during connection and disconnection.

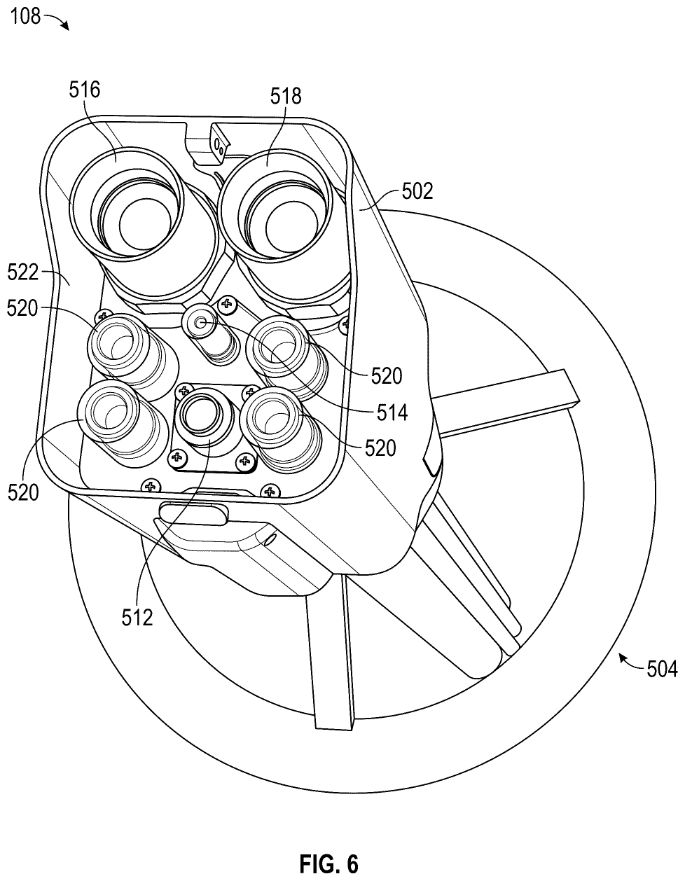

FIG. 6 is a further perspective view of a charge handle 108, according to some examples.

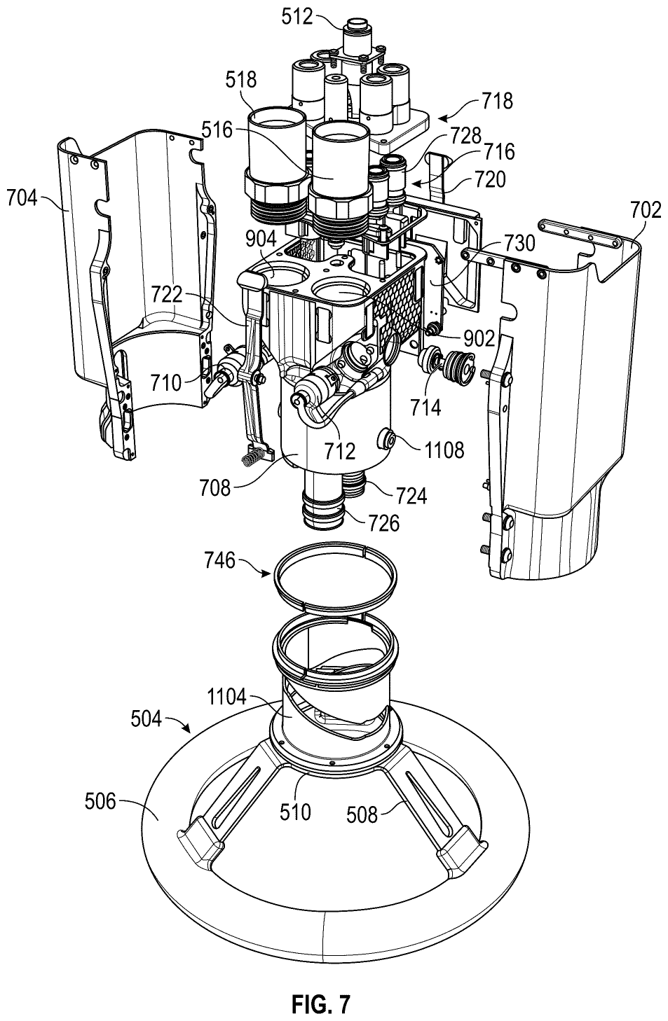

FIG. 7 illustrates an exploded view of a charge handle 108, according to some examples, offering more detailed information not visible in FIG. 5 and FIG. 6. Specifically, the housing 502 is shown to consist of a left shell 702 and a right shell 704. Enclosed within the housing 502 is a core 708, on top of which a lower housing 716 and an upper housing 718 are mounted and secured. The core 708 is slidably mounted within a helical cam 1104, which is secured to the wheel handle 504 to operatively rotate the helical cam 1104 as described in further detail below.

The core 708 has several internal channels and connectors. In FIG. 7, a pair of quick fluid connectors (e.g., coolant in connector 516 and coolant out connector 518) are threaded into correspondingly threaded ends of the coolant in channel 902 and the coolant out channel 904 of the core 708. Coolant flows through the coolant tubes of the hose and cable bundle 124 between the coolant reservoirs 118 and the aircraft 2400 through these channels in the charge handle 108. The core 708 facilitates the connection of the coolant in tube 404 and the coolant out tube 406 of the hose and cable bundle 124 to corresponding spigots, namely coolant in spigot 724 and coolant out spigot 726 that protrude from its proximal or lower end. These connections allow liquid coolant to enter the coolant in and coolant out channels within the core 708, ultimately feeding into the coolant in connector 516 and coolant out connector 518. More information about these coolant channels is discussed below.

The core 708 has internal passages or channels for electrical wiring that carries power and data. High-voltage aircraft charging conductors 408 of the hose and cable bundle 124 extend through channels in the core 708 to connect to socket couplers 728 of the lower housing 716 that fit inside the electrical connectors 520 of the upper housing 718. Likewise, chassis ground cables 416 of the hose and cable bundle 124 pass through the core 708 and are connected to the chassis ground connector 514.

Aircraft data links 412 and handle data links 414 connect through the core 708 to a (Printed Circuit Board) PCB assembly 730, which is secured to a side edge of the core 708. Aircraft data (e.g., telematics, battery data, etc.) is received from the aircraft 2400 is received into the charge handle 108 via the data offload and interlock 512, which is communicatively coupled to PCB assembly 730. Data to an aircraft 2400 is similarly provided from the ground support equipment 104 to the aircraft 2400 via data offload and interlock 512 after having been processed by the PCB assembly 730 or directly.

Focusing on the PCB assembly 730, this component converts aircraft data links 412 in the form of the T1 ethernet data links from the aircraft 2400 into standard Ethernet for transmission to the ground support equipment 104. The T1 data links, connected to the data offload and interlock 512, may not be able to maintain signal integrity over the full length of the hose and cable bundle 124. The T1 data links use a single twisted pair of wires, while standard Ethernet uses four twisted pairs, allowing it to handle higher data rates and maintain signal integrity over longer cable runs like the hose and cable bundle 124. T

To perform the data conversion, the PCB assembly 730 may contain the following components, merely for example:
T1/E1 line interface units to receive the T1 data links.
Ethernet transceivers to output Ethernet signals.
A field-programmable gate array (FPGA) or microcontroller to manage the conversion between protocols.
Surge protection and isolation circuits to protect from voltage spikes.
Status LEDs to indicate when the board is powered and operational.

The input T1 data links deliver data like charging parameters, telemetry, and safety information from the aircraft 2400 systems to the charge handle 108. The converted ethernet signal then transmits this data to the ground support equipment 104 (e.g., the system controller 202), which controls the charging process. The data conversion allows the aircraft 2400 to communicate with the ground support equipment 104 over the long hose and cable bundle 124 between the charge handles 108 and the ground support equipment 104, enabling an integrated system for managing the charging process. The data conversion uses standard telecommunications components to translate between the T1 data links and Ethernet protocols, allowing a charge handle 108 to act as an intermediary between the aircraft data networks and the ground support equipment 104. By converting the signal within a charge handle 108, it addresses the distance limitations of the T1 handle data links 414 and provides a robust data connection for monitoring and controlling the charging process. The data conversion helps enable communication between the aircraft 2400 and ground support equipment 104, thus facilitating safe and efficient battery recharging operations.

A pair of pressure sensors, pressure sensor 710 and pressure sensor 712, are also secured within the core 708 in order to detect pressure within the coolant in and coolant out chambers of the core 708. The pressure sensors are also shown to have external data leads that feed through the core 708 and provide pressure sensor data to the PCB assembly 730.

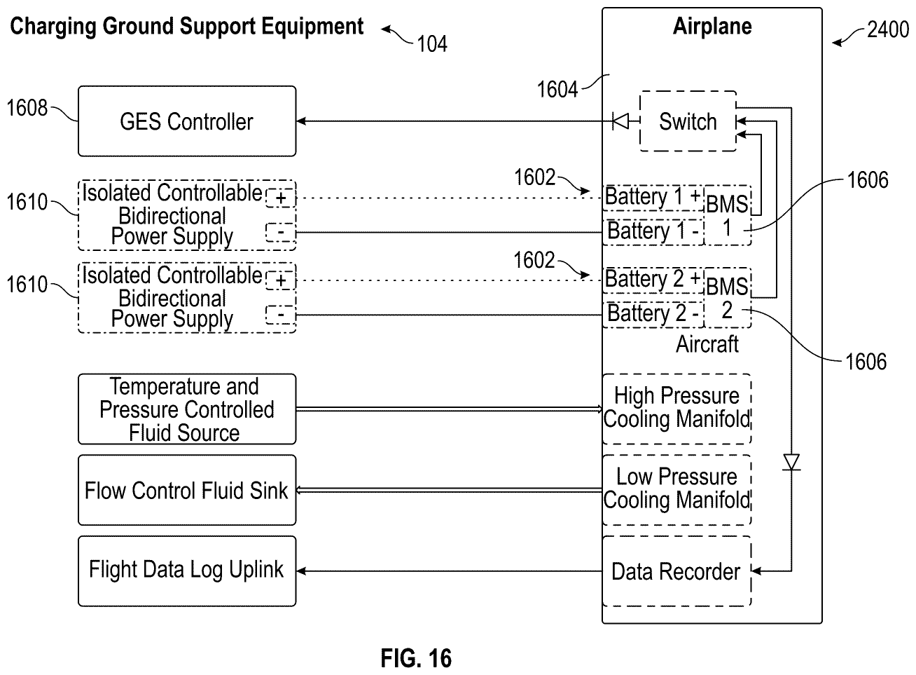

A pressure relief valve assembly 714 (which may comprise a recirculation valve) is also secured within the core 708 and operates to relieve excess pressure within the coolant in and coolant art chambers of the core 708, as described in further detail with respect to FIG. 16.

### Paddle Latch 804

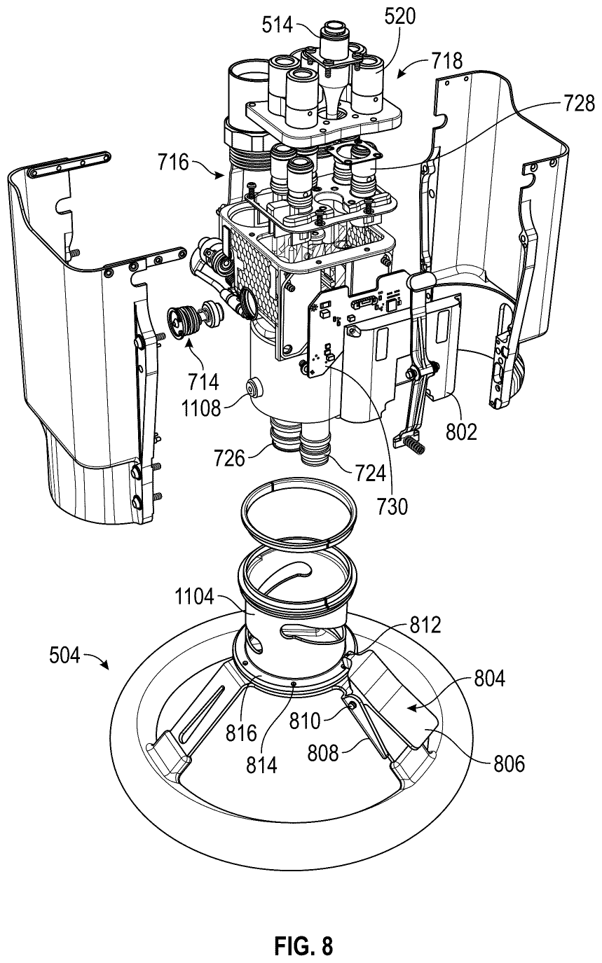

FIG. 8 is a further exploded view of the charge handle 108, from a front perspective, according to some examples. Here, a PCB cover 802 is shown to be placed over and secure the PCB assembly 730 in place on the side of the core 708. It will also be noted from FIG. 8 that the diameter of the coolant in spigot 724 is wider than the diameter of the coolant out spigot 726.

Additional details for the wheel handle 504 are also illustrated in FIG. 8. In particular, it consists of a circular ring base 506 with multiple arms 508 extending up and inward from the ring base 506 at an angle. These arms 508 connect to a smaller support ring 510, to which the helical cam 1104 is secured. One of the arms 508, is equipped with a paddle latch 804 for added security. The paddle latch 804 provides a mechanical locking feature to secure the wheel handle 504 when the charge handle 108 in the fully engaged or retracted positions. The paddle latch 804 prevents unwanted rotation or axial motion of the drive mechanism when engaged.

The paddle latch 804 has a latch arm 806, a latch base 808 and a latch spring (not shown). The latch arm 806 is pivotally attached to the latch base 808, allowing it to swing through an arc. The latch spring is coiled around a pivot pin 810 with one end connected to the latch arm 806 and the other end connected to the latch base 808. The spring provides a rotational force that biases the latch arm 806 downward into the locking position.

A free end of the latch arm 806 has a rigid tongue 812 that is angled to mate with a recess 814 (e.g., a series of holes or groves) defined in a flange 816 of the helical cam 1104. When the tongue 812 is aligned with a recess 814, the spring force pushes the latch arm 806 down, engaging the tongue 812 into a recess 814. This creates a positive mechanical lock.

To disengage the paddle latch 804, the user presses down on the free end of the latch arm 806. This deflects the latch arm 806, lifting the tongue 812 out of the recess 814. With the tongue 812 disengaged, the wheel handle 504 can be repositioned to a new location. Releasing the latch arm 806 allows the spring to push it back down. The tongue 812 then engages into a new recess 814 (or other retainer) corresponding to the new handle position.

This paddle latch 804 enables secure one-handed operation. The automatic spring-loaded locking gives the user confidence that the charge handle 108 is fully engaged or disengaged as needed for safe charging.

### Handle Latching Mechanism

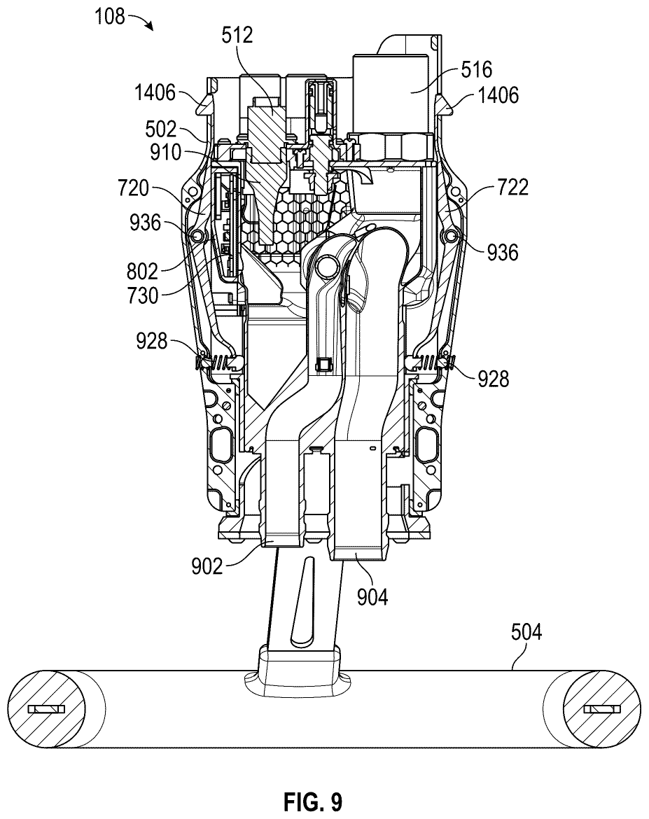

FIG. 9 is a cross-sectional side view of the charge handle 108, according to some examples. The cross-sectional view shows a coolant in channel 902 and a coolant out channel 904, which extend from a lower, proximal end of the charge handle 108 through the body of the core 708 (into which they are secured) and into fluid communication with the coolant in connector 516 and the coolant out connector 518 respectively, which extend from the upper, distal end of the charge handle 108. The upper ends of the coolant in channel 902 and coolant out channel 904 are threaded to provide a threaded engagement with each of the coolant in connector 516 and coolant out connector 518, respectively.

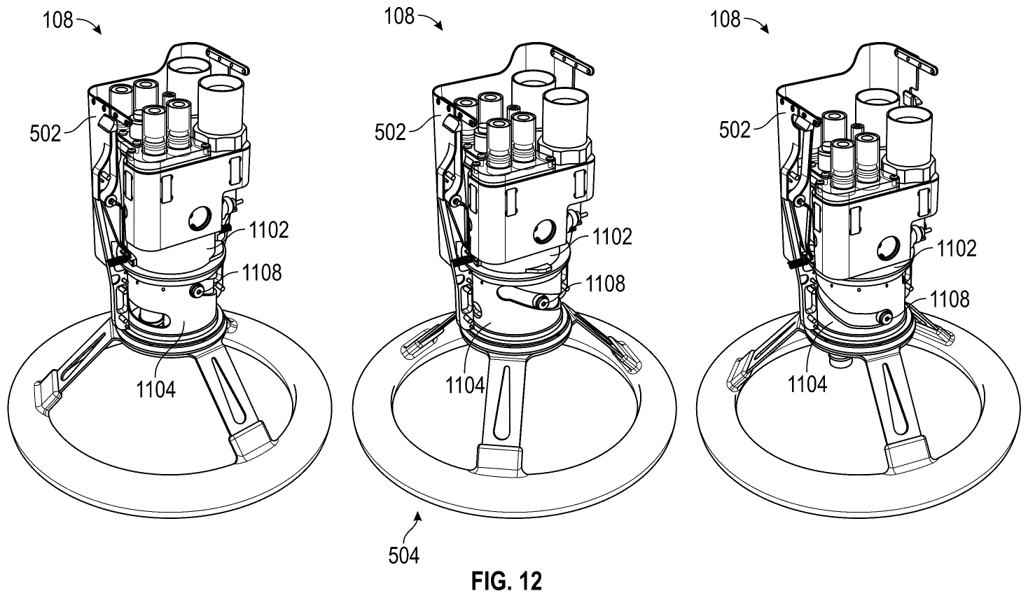

FIG. 8 also illustrates a latching mechanism that, in addition to securing and releasing engagement of a charge handle 108 to a charge port 106, operates to counter a force of a connection operation when connecting the charge handle 108 to a charge port 106. Such a force may react otherwise against the chassis of the aircraft 2400, as described above with reference to FIG. 12. This is to reduce a need, for example, for an operator from pushing up on a wing 2404 or against a fuselage 2402 during mating of the connectors of the charge handle 108 to the charge port 106 of an aircraft 2400, and in that way destabilizing the aircraft 2400.

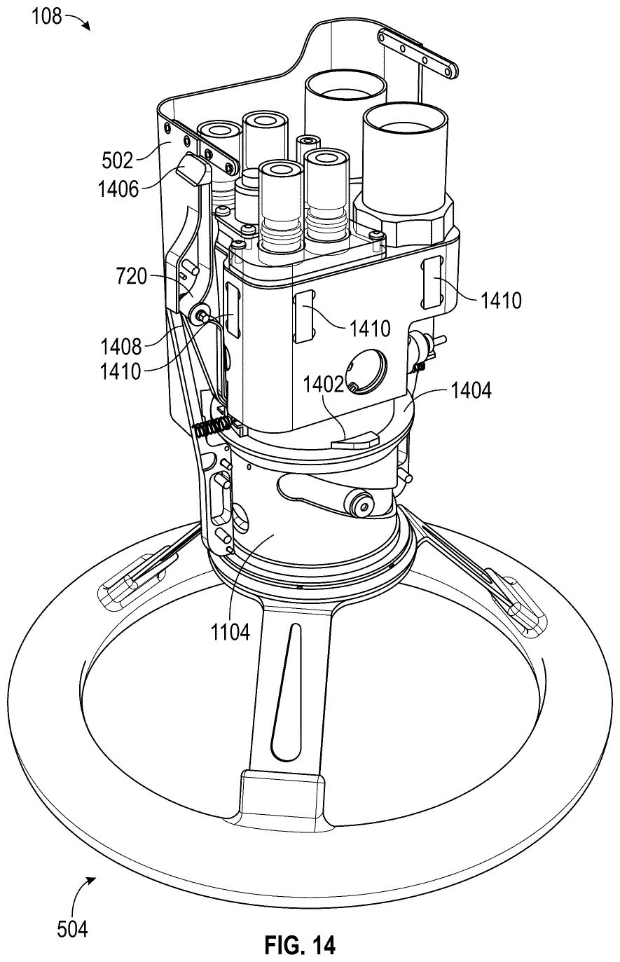

Operation of the latching mechanism will now be described with reference to both FIG. 9, FIG. 11, and FIG. 14. The latching mechanism is selectively disengaged by the drive mechanism of the charge handle 108 when the charge handle is in the disengaged position period. This allows an operator to conveniently push the charge handle 108 into an initial sliding engagement with the charge port 106 when the charge handle 108 is in the disengaged position. As the operator engages the drive mechanism to transition the charge handle 108 out of the disengaged position and towards the neutral and engaged positions, the latching mechanism serves to secure the charge handle 108 to the charge port and body of an electric vehicle.

The latch mechanism, in some examples, comprises one or more latch arms such as the front latch arms 720 and the rear latch arm 722. Each of the latch arms pivots around a pivot pin 936 that is secured in a cavity of the housing 502, as is apparent from FIG. 8. Each of the latch arms has a free end at which a latch tongue 1406 is formed or defined and a biased end that is biased by a respective spring 928. When outside of the disengaged position, the spring 928 biases a latch arm so that the biased end is forced away from the housing 502, and the latch tongue 1406 is protruded part of an aperture defined in the housing 502. When the charge handle 108 is secured within a charge port 106 outside of the disengaged position, the latch tongue 1406 protrudes or extends from the housing 502 and into a corresponding aperture in the charge port 106 in order to secure the charge handle 108 within the charge port 106 by preventing removal or withdrawal from the charge port 106.

However, when in the disengaged position, a cam lobe 1402 that is defined or carried on a helical cam 1104 of the drive mechanism (see FIG. 14) engages with a cam surface on the biased end of a latch arm, to push the biased end and to pivot the latch arm around the pivot pin 936, to thereby withdraw the tongue 1406 to within the housing 502.

Accordingly, an insertion operation by a user of the charge handle 106 into the charge port 106 begins with the user positioning the drive mechanism, using the wheel handle 504, in the disengaged position such that the cam lobe compresses the spring 928, and withdraws the latch tongue 1406 into the housing 502. The operator can then conveniently insert the free or upper end of the charge handle 108 into the charge port 106.

Once the charge handle 108 is inserted into the charge port 106, the operator then turns the wheel handle 504 to move the charge handle 106 out of the disengaged position, which causes the cam lobe to disengage and move off the biased end of the large arm. This causes the spring 928 to pivot the launch arm into an engaged position in which the tongue 1406 is protruded or extended from the housing 502 and into engagement with their corresponding recess in the charge port 106. In this way, the charge handle is locked in position within the charge port 106 and cannot be extracted without compromising the latch mechanism.

Similarly, to disengage and withdraw the charge handle 108 from a charge port 106, an operator turns the wheel handle 504 to a point where the charge handle enters the neutral position. On entering the neutral position, the cam lobe acts on the biased end of the latch arm to retract the latch tongue 1406 of the latch arm into the housing 502 and out of engagement with the charge port 106, allowing the charge handle to be withdrawn.

As also apparent from the description of FIG. 11, the helical cam 1104 has a pair of diametrically opposed cam drive slots 1106 defined therein. Each cam drive slot 1106 has a horizontal portion that transitions to an inclined portion. The horizontal portion is aligned with and positioned relative to the cam lobe 1402 such that, when disengaging the charge handle 108, as the cam follower stud 1108 moves from the inclined portion to the horizontal portion of the cam drive slot 1106, the cam lobes 1402 on the flange 816 of the helical cam 1104 act on the biased ends of the respective latch arms to retract the latch tongues 1406 into the housing. As the cam follower stud reaches the far end of the horizontal portion of the cam drive slot 1106, the latch tongues 1406 are fully retracted into the housing 502. Similarly, when engaging the charge handle 108, as the cam follower stud 1108 moves from the end position of the horizontal portion of the cam drive slot 1106, the cam lobe 1402 releases the biased ends of the latch tongues 1406 from the housing 502, which are then biased into engagement with corresponding recesses in the charge port engagement. This secures the charge handle 108 to the charge port 106 as the charge handle 108 drives from the disengaged position, through the neutral position, where the connectors begin mating in a frictional engagement with corresponding recesses or slots in the charge port 106.

The latching mechanism thus provides a safety mechanism that locks the charge handle 108 to a charge port 106 of the aircraft 2400 during engagement and releases without requiring the operator to push or pull against the charge port 106 or adjacent aircraft structure (e.g., a wing). The forces applied by the operator are instead reacted within the mechanism, avoiding destabilization of the aircraft 2400 that could potentially result from pushing or pulling on aircraft components.

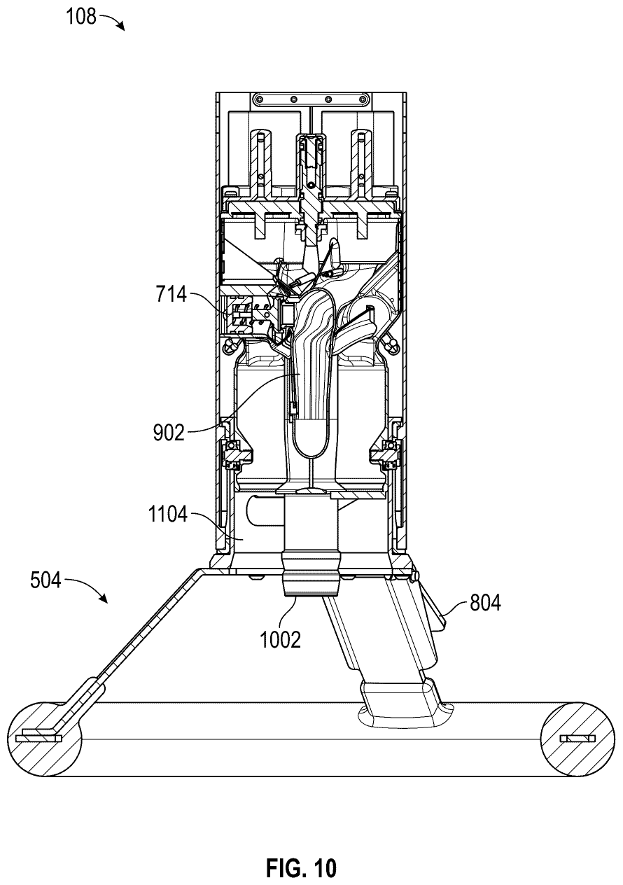

FIG. 10 shows a cross-sectional front view of the charge handle 108, according to some examples.

The cross-section illustrates the arrangement of the coolant in channel 902 and the pressure relief valve assembly 714 within the core 708. The pressure relief valve assembly 714 is in fluid communication with the interior of the coolant in channel 902 and is responsible for providing pressure relief in case the pressure within the coolant builds up. The lower end of the coolant in channel 902 is connected to a coupling spigot 1002. This spigot is operationally coupled to the coolant in tube 404 of the hose and cable bundle 124.

### Drive Mechanism

FIG. 11 is a cross-sectional view of the charge handle 108, according to some examples, illustrating details of the core 708 and a drive mechanism to move the core 708 between the engaged and disengaged positions.

The drive mechanism may provide a mechanical assist for engaging connections, enables self-contained driving forces entirely within the charge handle 108 itself, reduces loading on aircraft structures, and enables rigid positioning using sequenced latching and drive tube rotation.

The drive mechanism includes a helical cam 1104 with a pair of angled cam drive slots 1106 machined through it walls. The helical cam 1104 is a cylindrical component mounted concentrically within the handle housing 502. A cam drive slot 1106 is defined within the helical cam 11044 and winds around the helical cam 1104 at a constant angle offset from the axial direction. The angled cam drive slot 1106, at either ends of an angled center portion, includes a horizontal portion to enable a degree of rotation of the helical cam 1104 in respective engaged and disengaged positions without imparting an axial drive force.

A pair of cam follower stud 1108, one corresponding to each of the diametrically opposed cam drive slots 1106, are secured to or within the core 708. Each cam follower stud 1108 extends radially outward from the outer surface of the core 708. This cam follower stud 1108 engages within the cam drive slot 1106. The shape of the cam drive slot 1106 constrains the radial position of the cam follower stud 1108 while allowing axial movement of the core 708 as the helical cam 1104 is rotated.

As the helical cam 1104 is rotated, indicated by direction arrow 1110, the angled cam drive slots 1106 drive the cam follower studs 1108 and attached core 708 in axial directions indicated by the arrow 1114. This helical cam 1104 converts the rotary motion of the helical cam 1104 into linear motion to extend and retract the core 708, and thus the connectors of the charge handle 108 at the upper, free end of the core 708.

The angle of the cam drive slot 1106 determines the ratio of cam rotation to linear displacement. The cam angle may be determined to provide fine positional control and precise engagement of the connectors within their mating ports.

The helical cam 1104 is operationally rotated by a user-operated wheel handle 504. A mounting ring 510 of the wheel handle 504 is fixedly connected (e.g., welded) to the helical cam 1104 at a lower end thereof. In some examples (not shown), the wheel handle 504 may connect to the helical cam 1104 via precision gearing to enable smooth and controlled actuation of the mechanism. In these examples, bearings support the helical cam 1104 to minimize friction during operation. An upper end of the helical cam 1104 is rotatably coupled to the core 708 by an annual or ring bearing 746 that allows the helical cam 1104 to rotate relative to the core 708.

The wheel handle 504 provides an intuitive manual interface for the user to operate the helical cam drive mechanism during engagement and disengagement processes. As the user rotates the wheel handle 504, the angled cam drive slot 1106 then drives the cam follower stud 1108 axially, as detailed above. This extends or retracts the drive tube and attached connectors with fine positional control.

The mechanical advantage provided by the drive mechanism allows a user to generate the axial forces necessary to fully seat the connectors, even though the friction forces may be substantial. This overcomes a potential limitation of manual engagement.

The wheel handle 504 may incorporate features such as position detents, torque limiting, and position encoding to provide feedback on the status of the engagement process. This gives the user additional control over the engagement sequence for a safe and effective connection.

FIG. 12 illustrates the operation of the helical cam drive mechanism, according to some examples, through a sequence of perspective views showing the step-by-step motion of the core 708.

In the initial view, the core 708 is in the fully extended or engaged position with the connectors protruding from the mouth 522 of the housing 502. This corresponds to the cam follower stud 1108 being positioned at one axial extreme of the cam drive slot 1106.

As the user begins rotating the helical cam 1104 via the wheel handle 504, the angled cam drive slot 1106 drives the cam follower stud 1108, retracting the drive tube of the core 708 axially into the housing 502. This is depicted in the second view, which depicts the neutral position.

Continued rotation of the helical cam 1104 by the wheel handle 504 maintains engagement between the cam follower stud 1108 and cam drive slot 1106, steadily retracting the drive tube within the housing 502.

In the final view, the drive tube is fully retracted within the housing 502 of the core 708, position which corresponds to the cam follower stud 1108 reaching the opposite axial extreme of the cam drive slot 1106. The connectors are now fully within the housing 502 away from the mouth 522. This is the disengaged position.

The smooth transition between the distinct engaged, neutral, and disengaged positions of the drive tube 710 demonstrates the fine positional control enabled by the helical cam mechanism.

The perspective sequence in FIG. 12 further provides clear visualization of how the rotation of the helical cam 1104 via the wheel handle 504 axially drives the cam follower stud 1108 and attached drive tube. The position of the cam follower stud 1108 within the cam drive slot 1106 is evident in each view. As the helical cam 1104 rotates, the cam follower stud 1108 tracks along the cam drive slot 1106, converting the rotational input into linear motion. The engagement between the cam follower stud 1108 and cam drive slot 1106 is maintained throughout the rotation of the helical cam 1104. This transfers the rotational force into an axial retraction force to withdraw the drive tube into the housing 502.

The cam mechanism provides the controlled axial drive force necessary to disengage the connectors from their ports of a charge port 106 without the need for any motors or actuators on the aircraft side.

FIG. 12 also illustrates how this axial force originates from the wheel handle 504 itself as the helical cam 1104 rotates, rather than requiring any pushing by the user. This demonstrates an advantage of the self-contained drive mechanism. The self-contained drive mechanism design may provide advantages compared to traditional engagement system for this reason. For example, the mechanical components including the helical cam 1104 and the wheel handle 504 needed to generate the axial engagement force are entirely contained within the charge handle 108 itself. The drive mechanism allows the force to be pulled from the handle side as the helical cam 1104 rotates, rather than needing to be pushed from the vehicle side. Thus, the charge handle 108 may, in some examples, pull itself into engagement with a charge port 106, rather than requirement heavy pushing by a user or operator.

This in turn may enable removal or reduction of driving components from the aircraft 2400, this beneficially reducing the weight and mechanical complexity of the aircraft systems. It avoids increasing mass or volume requirements for the aircraft 2400.

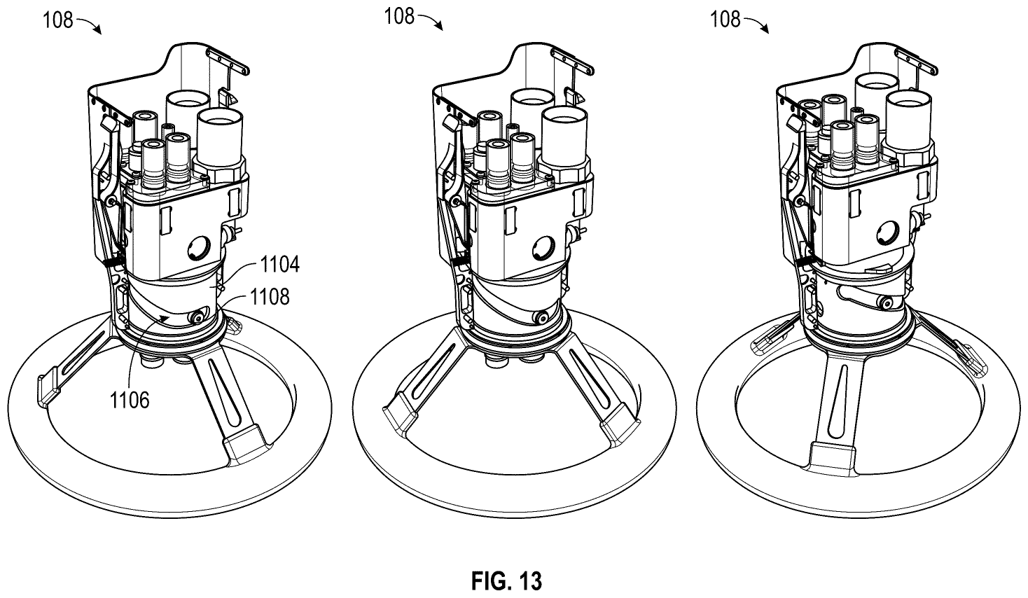

FIG. 13, as with FIG. 12, includes a sequence of perspective views of the charge handle 108, according to some examples, showing the driving of the core 708 within the housing 502, from the disengaged position to the neutral position, and then to the engaged position.

### Visual Indicators

FIG. 14 is a perspective view of the charge handle 108, according to some examples, illustrating further details of the latching mechanism that facilitates connection of a charge handle 108 to a charge port 106 of the aircraft 2400, and drive position viewing features.

The housing 502 further defines a number of position windows 1410 to provide views of the core 708 and the drive mechanism (e.g., the helical cam 1104, the cam ring 1404, etc.) within the housing 502 during engagement and disengagement operations. To this end, the core 708 and the drive mechanism include visual indicators (e.g., colored strips or other visual indicators) that align with the position windows 1410 depending on the position of the core 708 within the housing 502 or the rotation of the helical cam 1104. In this way, the alignment of the visual indicators with the position window 1410 enables a user or operator of the charge handle 108 to conveniently identify the position of the core 708 within and relative to the housing 502, and thus know the stage of engagement or disengagement of the charge handle 108.

Visual indicators are included on the cam ring 1404, which may protrude from the housing 502 and thus be visible to an operator. These visual indicators provide an indication of the degree of rotation of the drive mechanism within the housing 502 and provide a further indication to an operator of the stage of engagement and disengagement of the charge handle 108. In some more specific examples, the charge handle 108, as noted above, contains visual indicators on the core 708, drive mechanism (helical cam 1104 and cam ring 1404), and housing 502 that provide feedback to the operator on the position of the core 708 and stage of engagement. On the core 708, colored strips or other visual markers are placed at intervals corresponding to the engaged position, neutral position, and disengaged position. As the core 708 moves between positions, the visual indicators align with the position windows 1410 on the housing 502. This shows the operator the current position of the core 708. For example, when the core 708 is in the engaged position, a green indicator strip may align with the position window 1410. In the neutral position, a yellow indicator strip aligns with the position window 1410. In the disengaged position, a red indicator strip aligns with the position window 1410.

The helical cam 1104 and cam ring 1404 also contain visual indicators, such as colored dots, arrows, or numbering, around their circumference. As the helical cam 1104 and cam ring 1404 rotate to drive the core 708, the visual indicators rotate into view in the position windows 1410. The specific indicator visible in the position window 1410 identifies the degree of rotation of the drive mechanism, which corresponds to the position of the core 708. For example, as the helical cam 1104 rotates 90 degrees, an indicator marked ‘90’ may become visible in the position window 1410, showing the core 708 has moved from an engaged position to neutral position or neutral position to a disengaged position.

The visual indicators may be constructed from a durable, high-contrast material that is clearly visible through the position windows 1410, such as anodized aluminum, stainless steel, or high-temperature plastic. The indicators may be permanently and securely affixed to the core 708, helical cam 1104, and cam ring 1404, such as by stamping, laser etching, or mechanical fasteners, to withstand repeated use.

The alignment of the visual indicators with the position windows 1410 provides an intuitive interface for the operator to identify the position of the core 708 and ensure proper engagement or disengagement of the charge handle 108. The redundant indicators on multiple moving components, including the core cores 708, helical cam 1104, and cam ring 1404, add robustness to the visual feedback system.

### Pressure Relief Valve Assembly 714

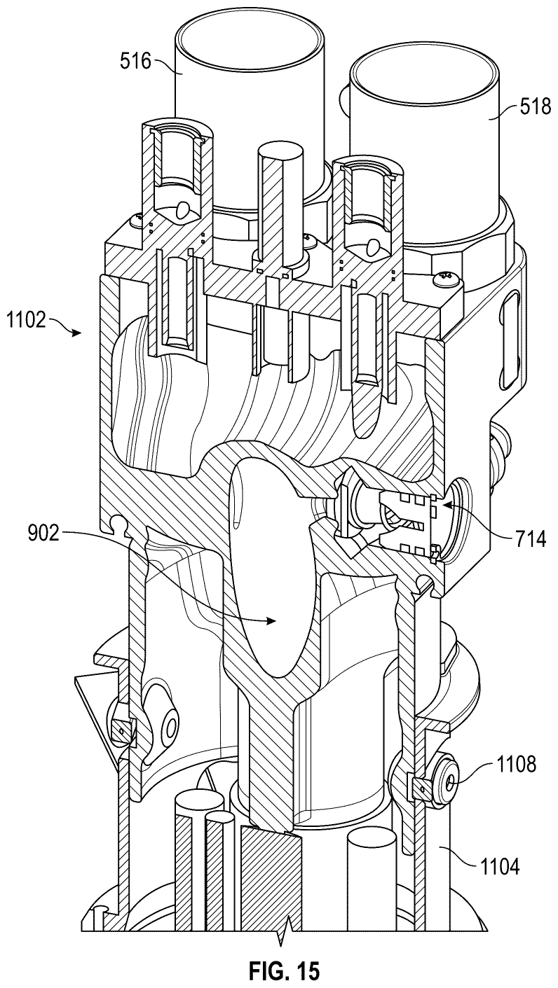

FIG. 15 is a cross-sectional view of the core 708, according to some examples, and shows the position and functioning of a pressure relief valve assembly 714 that operates as a recirculation valve. The pressure relief valve assembly 714 is in fluid communication with the coolant in channel 902 of a circulation circuit for coolant fluid within the charge handle 108 and specifically within the core 708 of the charge handle 108. When coolant pressure in the coolant in channel 902 exceeds the allowable threshold, the pressure relief valve assembly 714 opens to allow coolant pressure to be relieved into the low pressure coolant return passage (e.g., coolant out channel 904) of the charge handle 108.

Coolant fluid from the coolant reservoir 118 is supplied to the coolant in channel 902 through the hose and cable bundle 124 and conduit 120. The coolant fluid flows from the coolant in channel 902, through the coolant in connector 516 located at the distal end of the core 708, and into a corresponding connector within the charge port 106. From there, the coolant fluid flows into the battery conditioning system 204 of the aircraft 2400 where it is used to thermally manage the batteries during charging.

The pressure relief valve assembly 714 is a mechanical valve that operates to limit the pressure of the coolant fluid within the coolant in channel 902 and, accordingly, the pressure of the coolant fluid applied to the battery conditioning system 204. If the pressure differential across the pressure relief valve assembly 714 exceeds 25 PSI (or a determinable threshold), the force acting on an internal spring-loaded plunger causes the plunger to compress a spring within the valve and shift into an open position. This allows coolant fluid to flow from the inlet side of the pressure relief valve assembly 714, where coolant enters from the coolant in channel 902, to the outlet side in the coolant out channel 904, which leads back to the ground support equipment 104.

By opening at a threshold pressure of 25 PSI, the pressure relief valve assembly 714 prevents over-pressurization of the coolant system and water hammer effects that could damage components. High pressure in the coolant in channel 902, which could potentially be caused by a blockage or malfunction in the fluid circulation system 2504 of the aircraft 2400, is relieved by the pressure relief valve assembly 714 shunting coolant back to the ground support equipment 104. This restricts the buildup of excessive pressure and prevents damage to the aircraft 2400.

### GSE/Aircraft Interface 1604

FIG. 16 is a diagrammatic representation of an interface 1604 of the aircraft 2400, according to some examples, and connections between the aircraft 2400 and the ground support equipment 104 that may be facilitated via the interface 1604 of a single charge port 106. In this diagram, only a single charge port 106 is shown for the purposes of clarity, and the interface 1604 is present in each one of multiple charge ports 106 of the aircraft 2400.

The interface 1604 enables the isolated and controllable bidirectional supply of power to multiple isolated battery packs 1602 of the aircraft 2400, with pairs of battery packs 1602 being controlled by respective battery management systems 1606 (BMS's).

With respect to the ground support equipment 104, this equipment is turned to include a (Ground Equipment Support) GSE controller 1608 (e.g., the system controller 202), multiple isolated, controllable, and bidirectional power supplies 1610.

More specifically, the ground support equipment 104 contains multiple power supplies (e.g., as part of the AC supply hardware 206) to provide power to each of the four isolated battery packs on the aircraft. Two power supplies 1610 connect to each battery pack 2502 through the high-voltage pin connections of a charge handle 108.

The power supplies 1610 are isolated from each other to maintain separation between the battery packs 2502. This isolation is helpful for safety and redundancy. If one battery pack 2502 cannot be charged, the others can still be serviced.

The power supplies 1610 are controllable based on commands from the aircraft 2400. The aircraft 2400 specifies a charging profile for each battery pack 2502 including the voltage, current, and duration. The ground support equipment 104 adjusts each power supply to provide the requested charging profile for the associated battery pack 2502. The power supplies 1610 can also be controlled to stop charging if commanded by the aircraft 2400 or by the ground support equipment 104, responsive to automatic detection of a fault or responsive to user input.

The power supplies 1610 are bidirectional, allowing them to either charge or discharge the battery packs 2502. When charging, the power supplies 1610 provide power to the batteries. When discharging, the power supplies 1610 drain power from the batteries by providing a path to ground. The direction of power flow is controlled by the aircraft 2400 based on the needs of each battery pack 2502. Discharging may be necessary to reach a target charge level or for safety reasons.

The power supplies 1610 receive 3-phase 480V AC power and convert it to high-voltage DC power for charging the batteries. The AC power is provided by the charging site and converted by the ground support equipment 104. aircraft 2400

The power supplies 1610 are located within the AC supply hardware 206. Cables from the AC supply hardware 206 provide the high-voltage connections to the charging charge handles 108. The power supplies 1610 are controlled by the GSE controller based on signals from the aircraft 2400.

The isolated, controllable, and bidirectional power supplies 1610 provide a flexible solution for servicing the individual needs of each battery pack 2502 on the aircraft 2400. They allow for simultaneous charging or discharging at desired levels for each battery pack 2502 based on their state of charge and usage. The power supplies 1610 are designed to work together to fully recharge the aircraft 2400 as quickly as possible after each flight. In various examples, the multiple isolated power supplies 1610 may work together in the following ways to fully recharge the aircraft as quickly as possible:
The power supplies 1610 can simultaneously charge each of multiple battery packs (e.g., the four battery packs 2502) at or near their maximum rates. By charging all battery packs at once, the total recharge time is minimized.
The power supplies 1610 may provide different charging profiles to each battery pack based on their individual needs. The power supplies 1610 are controllable and can adjust the voltage, current, and duration for each battery pack based on its state of charge and chemistry. Battery packs that are more depleted can be charged at higher rates, while those closer to full can be charged at lower rates. This maximizes the charging for each pack and avoids overcharging.
The power supplies 1610 may make adjustments on the fly based on commands from the aircraft 2400. As battery packs 2502 approach full charge, the aircraft 2400 may request lower charging rates to avoid overcharging. The power supplies 1610 can quickly adjust to the new charging profiles for each pack upon request from the aircraft 2400. This allows for precision control and optimization of the charging process.
The power supplies 1610 provide redundancy in case one power supply cannot charge its associated battery pack. With multiple isolated power supplies, if one fails or cannot charge its pack, the others can continue servicing the remaining packs. This avoids delays in recharging the aircraft and ensures all functioning packs reach full charge.
The power supply 1610 can operate in either charging or discharging mode as needed for each battery pack. The power supplies are bidirectional, so they can work together to either recharge the battery packs by providing power or discharge them by draining power as commanded by the aircraft. Their ability to quickly switch between charging and discharging based on the aircraft's requests allows for complete management of the battery packs' state of charge.

The multiple power supplies 1610 are designed with the capacity, controllability, and flexibility to work together in servicing the needs of each battery pack 2502 and recharging the aircraft 2400 rapidly. By operating simultaneously at commended levels for each battery pack 2502, they reduce total recharge time while maintaining precision control and redundancy. Their ability to switch seamlessly between charging and discharging modes provides control over the battery packs' state of charge. The power supplies 1610 function cohesively based on inputs from the aircraft 2400 to fully recharge the aircraft after each flight.

### Process Overviews

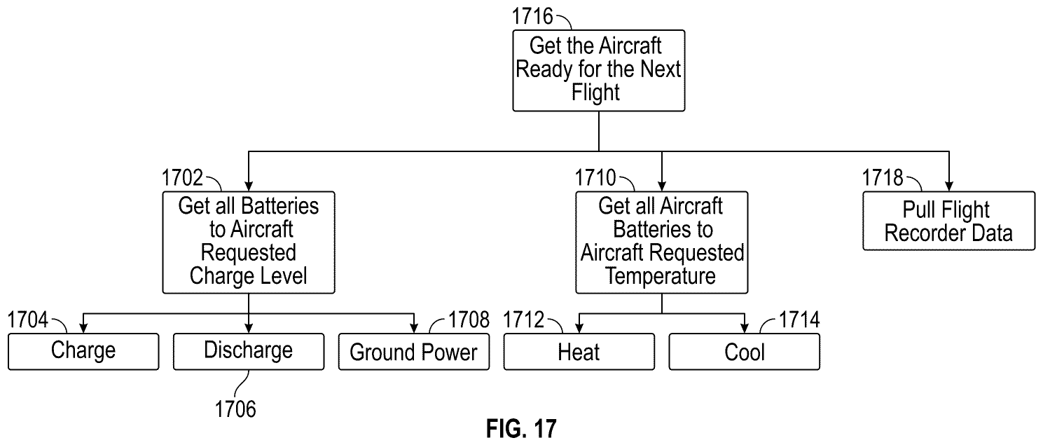

FIG. 17 is a flowchart illustrating operations, according to some examples, performed by the ground support equipment 104 to ready an aircraft 2400 for a flight.

The top-level operation illustrated in FIG. 17 is ‘Get aircraft ready for next flight’ (1716). This overarching operation refers to using the ground support equipment 104 to fully prepare the aircraft 2400 for its subsequent flight after landing. It contains three main sub-operations:

Operation 1702: Get all batteries to aircraft requested charge level: This operation charges or discharges the aircraft's batteries to reach a target state of charge (SOC) specified by the aircraft 2400. The ground support equipment 104 provides power to or drains power from respective battery packs 2502 through electrical connections in the charge handle 108. The ground support equipment 104 supplies DC power to a battery pack 2502 at a controlled voltage and current based on the battery chemistry and requested charge rate. The power is provided through four isolated high-voltage pin connections as described above, two for each battery pack 2502. The charging profiles for each battery pack 2502 are specified by the aircraft 2400 based on their individual SOCs and maximum charge rates.

If requested by the aircraft 2400, the ground support equipment 104 drains power from the battery packs 2502 by providing a path to ground through the charge handle 108. The ground support equipment 104 controls the discharge rate for each battery pack 2502 based on specifications from the aircraft 2400. Discharging the battery packs 2502 may be necessary to reach a target SOC or for safety reasons. The ground support equipment 104 provides AC or DC power through connections in the charge port 106 to support aircraft 2400 systems during charging and discharging. This power may be used for functions other than charging the battery packs 2502 such as climate control, avionics, and other components. The ground support equipment 104 continues supplying ground power until the aircraft 2400 is ready to switch to its own battery power.

Operation 1710: Get all aircraft batteries to aircraft requested temperature: This operation heats or cools the battery packs 2502 to reach a target temperature specified by the aircraft 2400. The ground support equipment 104 flows a temperature-controlled coolant through the charge handle 108 to raise or lower the battery temperature. The ground support equipment 104 supplies warm coolant by operating a chiller 116 in heating mode. The coolant flows through channels in the charge handle 108, and through the coolant in connector 516 and coolant out connector 518, to heat the battery packs 2502 and maintain a desired temperature for charging or to prepare for takeoff.

The ground support equipment 104 supplies chilled coolant by operating a chiller 116 in cooling mode. The chiller 116 chills the coolant to as low as −10° C. The coolant is pumped from the coolant reservoir 118 to the charge handle 108 at a rate of up to 45 lpm. The coolant flows through connections in the charge handle 108 to lower the battery temperature after charging and maintain it at a level suitable for the next flight. Cooling the battery packs 2502 also allows them to act as a heat sink during flight.

Operation 1718: Pull flight recorder data: This operation refers to offloading data from the data acquisition and flight recording systems of the aircraft 2400. The ground support equipment 104 retrieves the data through Ethernet and T1 data connections in the charge handle 108, specifically through the data offload and interlock 512, and transfers it for storage and analysis. The data may include telemetry, system statuses, error codes, flight profiles, and other information from a previous flight. The ground support equipment 104 continues offloading data until requested information has been retrieved.

The ground support equipment 104 is designed to fully support the aircraft 2400 between flights by managing its isolated battery packs 2502, temperature, data, and power needs.

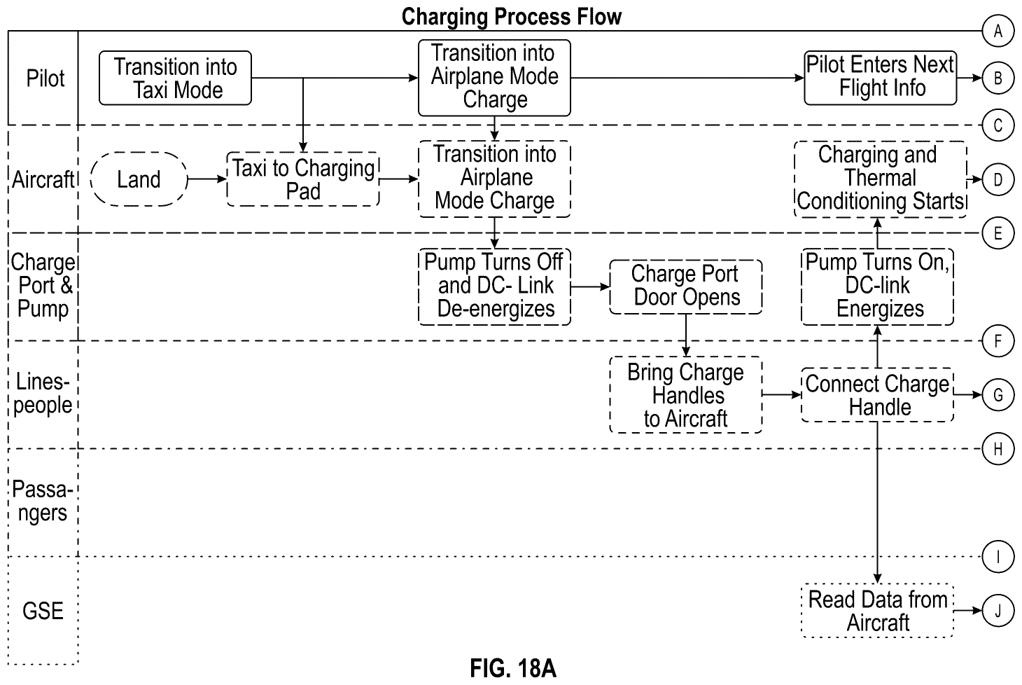

FIG. 18A and FIG. 18B show a flowchart depicting further details of methods, according to some examples, to charge and condition an electric aircraft 2400 for a flight. Various operations that may be performed by a pilot, the aircraft 2400, a charge port 106 and pump, lines people, passengers and the ground support equipment 104 are illustrated in the flowchart.

### Method—Engagement of Charge Handle 108

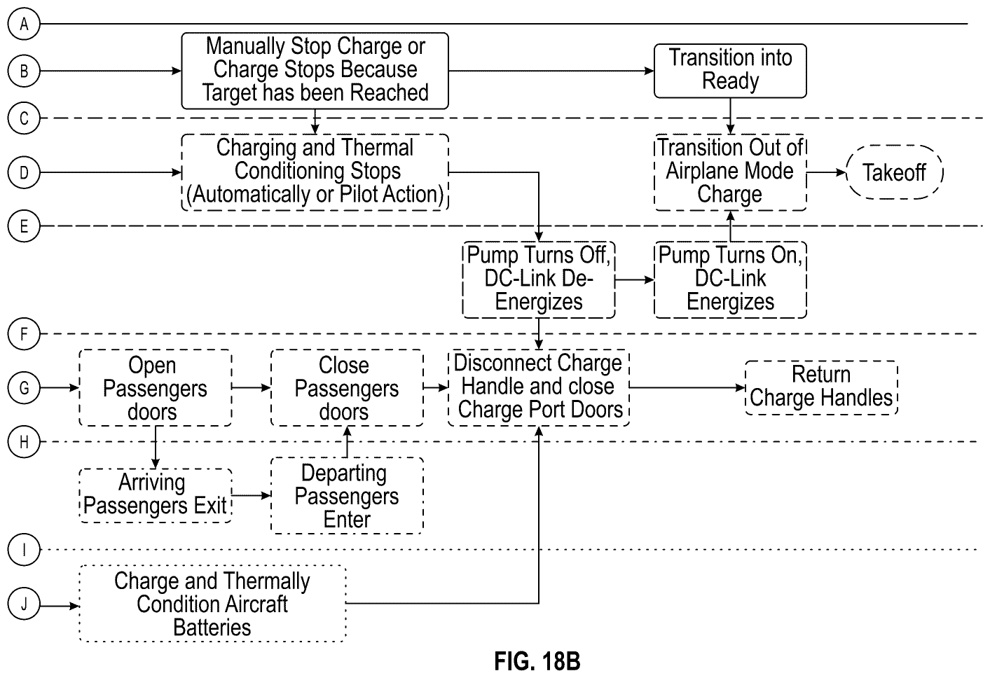

FIG. 19 is a flowchart illustrating a method 1900, according to some examples, of engaging the charge handle 108 with a charge port 106 of an electric vehicle, such as the aircraft 2400. The method 1900 will be described with specific reference to the sequence of images shown in FIG. 13 showing the transition of a charge handle 108 from a disengaged position or state to a neutral position.

In block 1902, the method 1900 commences with an operator or user placing the charge handle 108 in a disengaged position or state by rotation of the wheel handle 504 so that the charge handle 108 is in the position illustrated in the first image of FIG. 13 Here, it will be noted that the cam follower stud 1108 is positioned within the horizontal portion of the cam drive slot 1106 defined in the helical cam 1104. As explained above, when the wheel handle 504 is in this state, the rotational position of the wheel handle 504 is such that the cam lobes 1402 on the cam ring 1404 pivot the latch arms to withdraw the tongues into the housing 502. Accordingly, a user can conveniently and easily slide the mouth of the housing 502 into a corresponding structure within the charge port 106.

Having inserted a free end of the charge handle 108 into engagement with a corresponding charge port 106 of an electric aircraft 2400, an operator may secure the housing 502 of the charge handle 108 to a charge port 106 of the electric aircraft 2400 using the latching mechanism. In some examples, and as described above, the latching mechanism comprises a pivoting front latch arm 720 and a pivoting rear latch arm 722 that engage with corresponding structures (e.g., recesses) on the interior of a charge port 106 to secure the charge handle 108 in place during engaged position and neutral position, and that disengages from the corresponding structures on the interior of the charge port 106 to allow the charge handle 108 to be withdrawn from mating engagement with the charge port 106 when in a disengaged position. The latching mechanism engages and operates with the drive mechanism, including a cam lobe 1402 on a cam ring 1404, to secure the housing 502 to the electric aircraft 2400 when the charge handle 108 is outside of the disengaged position and to release the charge handle 108 from the engagement with the electric aircraft 2400 when the charge handle 108 is in the disengaged position. The cam lobe 1402 engages with a cam follower of each of the latch arms to pivot the latch arms between a locked position when the charge handle 108 is outside of the disengaged position and a release position when the charge handle 108 is in the disengaged position.

Returning to the engagement process, to lock the charge handle 108 to a charge port 106, and accordingly to the aircraft 2400, each of the latch arms has a latch tongue 1406 at a free end thereof that is located substantially inside or within the housing 502 when the charge handle 108 is disengaged from a corresponding charge port 106, but is pivoted into engagement with a recess or retention slot defined within the charge port 106 when the charge handle 108 is engaged with the corresponding charge port 106. The latching mechanism seeks to ensure that a force of a connection operation connecting the charge handle 108 to a charge port 106 reacts against the chassis of the aircraft 2400. This is to reduce the need for an operator push-up on a wing during the connection of the charge handle 108 to the charge port 106, and in that way destabilizing the aircraft 2400.

Become as part of the engagement process, once the charge handle 108 is inserted into the charge port 106, the operator rotates the wheel handle 504, which then engages with the cam follower stud 1108 with the lower surface of the cam drive slot 1106 to transition the charge handle 108 out of the engaged position or state. This in turn disengages the cam lobe 1402 from the biased end of each of the latch arms so that springs 928 pivots each of the latch arms, causing the respective latch tongues 1406 to protrude from the housing 502 and to lock into position within the corresponding structures of the charge port 106.

In block 1904, an operator drives the core 708 within the housing 502 from the disengaged state shown in the first two images of FIG. 13, to the neutral state shown in the third image of FIG. 13. The drive mechanism includes a helical cam 1104 having a cam drive slot 1106 defined therein. The helical cam 1104 drives the core 708 from the retracted position through the neutral position and to the extended position. The cam follower stud 1108 of the core 708 is accommodated within the cam drive slot 1106 and facilitates this driving in an axial direction as described above. Specifically, user rotation of a wheel handle 504 rotates the helical cam 1104, driving the core 708 between positions by the application of force between the cam follower stud 1108 and the walls of the cam drive slot 1106.

The helical cam 1104 and cam ring 1404 also contain visual indicators, such as colored dots, arrows, or numbering, around their circumference. As the helical cam 1104 and cam ring 1404 rotate to drive the core 710, the visual indicators rotate into view in position windows 1410. The specific indicator visible in the position window 1410 identifies the degree of rotation of the drive mechanism, which corresponds to the position of the core 708.

In block 1906, an operator, by continued rotation of the wheel handle 504, drives the core 710 from the neutral position and towards the engaged position, to thereby extend the fluid connectors (e.g., coolant in connector 516, coolant out connector 518), electrical connectors (e.g., electrical connectors 520) and a data connector (e.g., data offload and interlock 512) relative to the housing 502 of the charge handle 108. As the core 708 transitions from the neutral position and into the engaged position, the connectors are driven into mating engagement with corresponding sockets within the charge port 106. The latch arms, and particularly the under surfaces of the latch tongues 1406, enable the connectors of the core 708 to be pulled, by continued rotation of the wheel handle 504, towards and beyond the mouth 522 of the housing 502 and to overcome mating resistance caused by insertion of the connectors into these corresponding sockets. In this way, an operator of the charge handle 108 does not need to push the charge handle 108 to overcome the frictional resistance, but can rather rotate the wheel handle 504, thus causing the connectors to be pulled into the corresponding sockets.

Disengagement of the charge handle 108 from the charge port 106 involves a sequence of operations in reverse from what is described above. With reference to FIG. 12, when in the engaged position, the connectors of the charge handle 108 are in a mated engagement with corresponding sockets of the charge port 106. The first image of FIG. 12 illustrates the charge handle 108 in an extended, engaged position, with the cam follower stud 1108 being located at an upper end of the cam drive slot 1106. To disengage the charge handle 108 from the charge port 106, operator rotates the wheel handle 504 so that a cam follower stud 1108 progresses within a cam drive slot 1106 towards the position shown in the second image of FIG. 12, corresponding to the neutral position. When in the neutral position, the latch tongues 1406 of the latch arms are still engaged with the corresponding slots of the charge port 106 to secure the charge handle 108 to the charge port 106. However, in the neutral position, the connectors of the charge handle 108 are withdrawn from the mating engagement with the corresponding sockets of the charge port 106. Continued rotation of the wheel handle 504 by the operator causes further downward axial motion of the core until the cam follower stud 1108 reaches the lower end of the cam drive slot 1106 to fully place the charge handle 108in a disengaged position, at which point the latch tongues 1406 of the latch arms are withdrawn into the housing 502 of the charge handle 108. The charge handle 108 may then conveniently be withdrawn from the charge port 106.

The drive mechanism, including the helical cam 1104, cam follower stud 1108, and wheel handle 504, provides controlled extension and retraction of the connectors from the housing 502. The latching mechanism, including the pivoting front latch arm 720, cam lobe 1402, and cam ring 1404, securely locks the charge handle 108 to the charge port 106 when the connectors are extended to enable charging operations while avoiding pushing against the charge port 106 or aircraft 2400. The visual indicators on the drive mechanism provide feedback to the operator on the position of the core 710 and stage of engagement.

### Method—Sequenced Connection

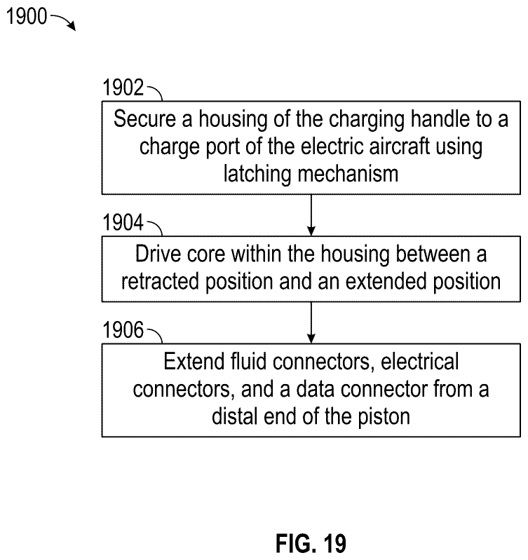

FIG. 20 is a flowchart illustrating a method 2000, according to some examples, for engagement of a charge handle 108, as described above, with a charge port 106 of an electric vehicle in the example form of an aircraft 2400.

In block 2002, the method 2000 engages, by the charge handle 108, a chassis ground connector 514 of the charge handle 108 with a corresponding grounding connector within a charge port 106 of the aircraft 2400. The chassis ground connector 514 is coupled to a grounding chassis ground cable 416, as shown in FIG. 4, that provides a low-resistance path to ground. This helps discharge static buildup that could damage sensitive components and ensures the charge handle 108, and the charge port 106 are at the same electrical potential before energizing other systems of the ground support equipment 104. The chassis ground connector 514 engages first to mitigate risks like arcing that could result from connecting high-voltage systems at different potentials, for example.

In block 2004, the method 2000 engages, by the charge handle 108, one or more fluid connectors, specifically coolant in connector 516 and coolant out connector 518, of the charge handle 108 with corresponding one or more fluid connectors within the charge port 106 after engaging the chassis ground connector 514. The coolant in connector 516 and coolant out connector 518 are coupled to coolant in tube 404 and the coolant out tube 406 respectively, which allow cooling fluid flow before energizing the high-voltage systems. The fluid connectors may each comprise a dry break coupler, as described above, to allow a fluid connection to be made between the charge handle 108 and the aircraft 2400 without leaking fluid or allowing air into the system. The dry break coupler may consist of a cylinder with O-rings around its interior perimeter that create a seal when the male and female sides of the coupler are connected. When the male section of the dry break coupler is inserted into the female section, O-rings seal against the surfaces of the male section, allowing pressurized coolant to flow through the connection. The tight seal created by the O-rings prevents any leakage of coolant or ingress of air at the connection point.

In block 2006, the method 2000 engages, by the charge handle 108 one or more electrical connectors 520 of the charge handle 108 with corresponding one or more electrical connectors within the charge port 106 after engaging the one or more fluid connectors. The electrical connectors 520 are coupled to high-voltage aircraft charging conductors 408, as shown in FIG. 4, that have insulated sleeves to prevent arcing during connection. The power connections are made after grounding and cooling fluid flow are established for safety. The electrical connectors 520 may facilitate the concurrent charging or discharging of the respective first and second isolated battery packs 2102 of the electric aircraft 2400.

In block 2008, the method 2000 engages, by the charge handle 108, a data connector, specifically the data offload and interlock 512, of the charge handle 108 with a corresponding data connector within the charge port 106 after engaging the one or more electrical connectors 520. The data offload and interlock 512 is coupled to an aircraft data link 412, as shown in FIG. 4, that provides monitoring and control of the charging process. The data offload and interlock 512 may be the last connection made to avoid data transfer before the power systems are properly grounded and cooled. The data offload and interlock 512 may facilitate a transfer of data between the electric aircraft 2400 and an external data system, such as the system controller 202.

The sequencing and physical design of the connectors in the charge handle 108 mitigate risks like arcing, overheating, and static discharge during connection and disconnection with the charge port 106. The grounding, fluid, high-voltage electrical, and data connections are engaged in a controlled sequence to ensure the safe operation of the charging system.

### Method—Operation of Ground Support Equipment 104

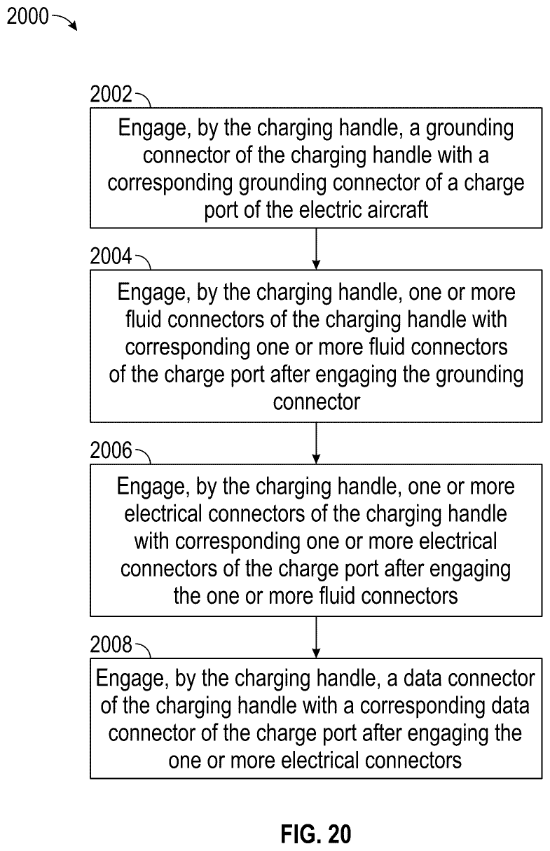

FIG. 21 is a flowchart illustrating a method 2100, according to some examples, of operating ground support equipment 104 with respect to an electric vehicle, such as for example aircraft 2400 or a motor vehicle.

In block 2102, the method 2100 provides, via fluid connectors in the form of the coolant in connector 516 and coolant out connector 518 of a charge handle 108, a coolant fluid from a fluid source external to the aircraft 2400, such as the coolant reservoir 118, to thermally manage the aircraft 2400. The coolant fluid is applied in order to thermally manage the aircraft 2400 during electrical charging and discharging of battery packs 1602 of the aircraft 2400.

The coolant in connector 516 and coolant out connector 518 are coupled to coolant in tube 404 and the coolant out tube 406, shown in FIG. 4, to convey the coolant fluid from the charge handle 108 to the aircraft 2400. A pump, such as one of the pumps 302, pumps the chilled coolant from the coolant reservoir 118 to the coolant in connector 516 and coolant out connector 518 at a rate of up to 45 lpm. The coolant flows into the fluid circulation system 2504 of the aircraft 2400 and returns to the coolant reservoir 118, where it is re-chilled by a chiller 116. Temperature and pressure sensors within the cooling system and charge handle 108 may monitor the coolant flow and provide data to the system controller 202 to control the pumps 302 and ensure proper thermal management.

In block 2104, the method 2100 provides, via electrical connectors 520 of the charge handle 108, at least one of charge or discharge of respective first and second isolated battery packs 2502 of the electric aircraft 2400 from an electric source external to the electric aircraft 2400, such as the charger 114. The electrical connectors 520 are coupled to high-voltage aircraft charging conductors 408 to facilitate the charge or discharge of the respective first and second isolated battery packs 1602. The electrical connectors 520 may facilitate the concurrent charging or discharging of the respective first and second isolated battery packs 1602 of the electric aircraft 2400.

The charger 114 may provide up to 750 VDC and 130 A of power to the electrical connectors 520 for charging the battery packs 1602. The charger 114 adjusts the voltage and current to each electrical connector 520 based on the needs of the connected battery pack 1602. The system controller 202 coordinates the charging profiles for each battery pack 1602 based on their state of charge and chemistry. Voltage, current, and temperature data from the battery packs 1602 and charge handle 108 provide feedback to control the charging process.

In block 2106, the method 2100 facilitates, via a data connector, specifically the data offload and interlock 512, of the charge handle 108, a transfer of data between the electric aircraft 2400 and an external data system, such as the system controller 202. The data offload and interlock 512 is coupled to an aircraft data link 412 to facilitate the data transfer, as shown in FIG. 4. The data offload and interlock 512 may facilitate a transfer of data between the electric aircraft 2400 and an external data system, such as the system controller 202.

The data offload and interlock 512 transmits data like charging parameters, telemetry, and safety information from the aircraft 2400 systems to the system controller 202. The system controller 202 then controls components like the charger 114 and cooling system based on this data to properly manage the charging process. The data offload and interlock 512 also provides a signal to the system controller 202 when the charge handle 108 is properly engaged or disengaged from the charge port 106.

The charge handle 108 provides connections for power, data, and coolant flow between the ground support equipment 104 and the aircraft 2400. The components, data, and signals involved in these connections enable automated, high-powered charging and advanced thermal management of the battery systems.

Method—Data Exchange with Ground Support Equipment 104

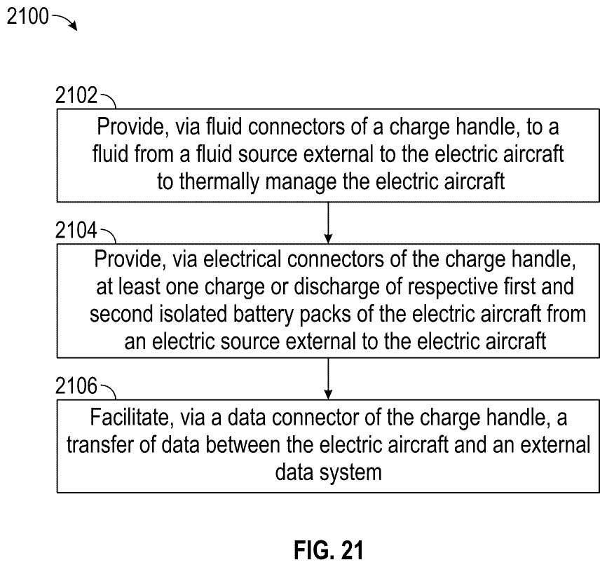

FIG. 22 is a flowchart illustrating a method 2200, according to some examples, to operate a charging station, in the example form of the ground support equipment 104.

In block 2202, the method 2200 receives, by the ground support equipment 104, a first signal from a charge handle 108 coupled between an electrically powered vehicle, in the example form of the aircraft 2400, and a charging station in the example form of the ground support equipment 104. The first signal indicates that the charge handle 108 is properly engaged with the charge port 106. This first signal is received through the data offload and interlock 512, which provides a signal to the system controller 202 when the charge handle 108 is properly engaged or disengaged from the charge port 106.

The data offload and interlock 512 contains a switch that closes when the charge handle 108 is engaged to the charge port 106, sending the first signal to the system controller 202. The system controller 202 then begins a handshaking process with the aircraft 2400, exchanging authentication keys to verify the connection before energizing the systems.

In block 2204, the method 2200 initiates, by the ground support equipment 104, one or more battery chargers, for example the power supplies 1610 of the charger 114, and one or more coolant pumps, for example the pumps 302, in response to the first signal to provide power and cooling to the electric aircraft 2400. The system controller 202 coordinates the charging profiles for each battery pack 1602 based on their state of charge and chemistry, for example. The pumps 302 pump chilled coolant from the coolant reservoir 118 to the charge handle 108 at a rate of up to 45 lpm, for example.

The system controller 202 sends signals to turn on the charger 114 and pumps 302 after the handshaking process is complete. The charger 114 begins providing power to the electrical connectors 520 at the voltage and current levels specified by the aircraft 2400 for each battery pack 1602. The pumps 302 start circulating chilled coolant from the coolant reservoir 118 to the charge handle 108, which is then provided via the coolant in connector 516 to the aircraft 2400 to begin cooling the battery packs 1602. Temperature sensors in the battery packs 2102 and charge handle 108 may provide feedback to monitor the temperatures during charging.

In block 2206, the method 2200 transmits, by the ground support equipment 104, a second signal to the charge handle 108 to start data offload from the electric aircraft 2400. The second signal is transmitted from the system controller 202 to the charge handle 108 through the data offload and interlock 512.

Once charging and cooling have started, the system controller 202 sends the second signal through the data offload and interlock 512 to request data offload from the aircraft 2500 aircraft 2900. This initiates the transfer of data like flight profiles, error codes, and telemetry through the data offload and interlock 512 to the system controller 202.

In block 2208, the method 2200 receives, by the ground support equipment 104, flight data, telemetry data, and pressure data via the charge handle 108, the flight data, the telemetry data, and the pressure data being in an Ethernet format. The charge handle 108 converts the T1 aircraft data links 412 from the aircraft 2500 aircraft 2900 into Ethernet for transmission to the ground support equipment 104. The data includes information like charging parameters, telemetry, system statuses, error codes, flight profiles, and pressure readings from sensors in the charge handle 108 and cooling fluid circulation systems 2504 of the aircraft 2900.

The data offload and interlock 512 receives the T1 data via the aircraft data link 412 from the aircraft 2400 systems. The charge handle 108 then converts this data into Ethernet signals, which it transmits to the system controller 202. Pressure data comes from pressure sensors, such as pressure transducers, within the charge handle 108 that monitor the coolant pressure. The system controller 202 logs all data received for each charging session.

In block 2210, the method 2200 controls, by a system controller 202 of the ground support equipment 104, the one or more battery chargers, for example the power supplies 1610 of the charger 114, and the one or more coolant pumps, specifically the pumps 302, based at least in part on the pressure data. The system controller 202 adjusts the charger 114 and pumps 302 to maintain proper temperatures and charge rates for the battery packs 1602 based on the pressure data and other feedback. If the pressure data indicates an overpressure condition, the system controller 202 can reduce or stop coolant flow to avoid damage to the aircraft 2400.

The system controller 202 monitors the pressure data and other telemetry from the sensors and aircraft 2500 aircraft 2900 during charging. If the pressure data shows the coolant pressure rising above a threshold pressures (e.g., 25 PSI), the system controller 202 sends signals to slow or stop the pumps 302 to prevent over pressurization. Once the pressure drops below the threshold pressure (e.g., 25 PSI) again, the pumps 302 reactivate. The system controller 202 can also adjust the charger 114 up or down based on the temperatures reported by the sensors to maintain desired levels for charging. If any data indicates a fault or unsafe condition, the system controller 202 immediately cuts off power and coolant to mitigate risks.

In summary, the ground support equipment 104 receives signals and data from the charge handle 108 to initiate and control charging operations for the electric aircraft 2500 aircraft 2900. The system controller 202 activates components like the charger 114 and pumps 302 in response to the first signal indicating the charge handle 108 is engaged. It then receives data including pressure readings from the charge handle 108 to monitor the charging process and make adjustments as needed. The ground support equipment 104 and charge handle 108 work together to enable automated, high-powered charging and advanced thermal management of the battery systems.

### Method—Charge Provision Through Multiple Isolated Power Supplies 1610

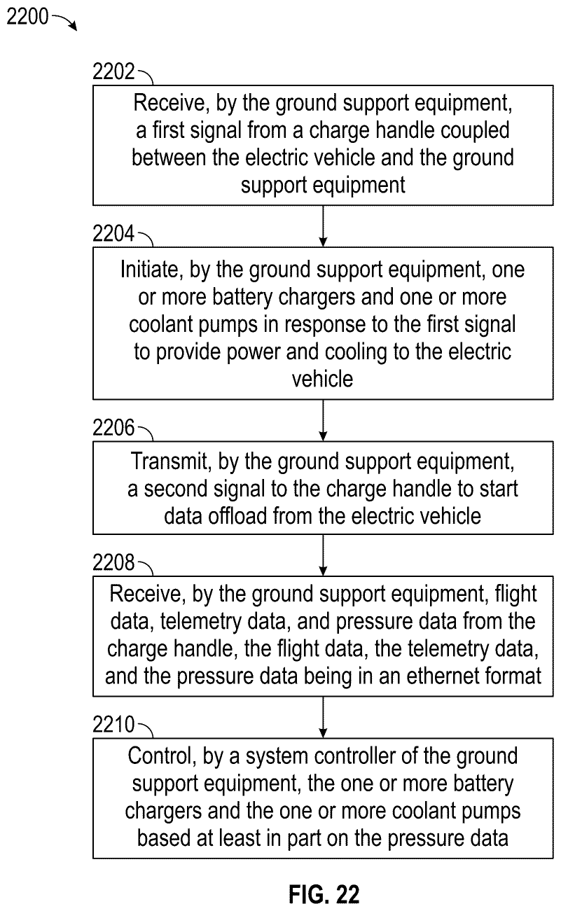

FIG. 23 is a flowchart illustrating a method 2300, according to some examples, to operate a charging station, in the example form of the ground support equipment 104, having multiple power supplies 1610.

In block 2302, the method 2300 activates a charger 114 comprising a plurality of isolated power channels. The charger 114 may include a four channel, 400 kW AC-DC charging cabinet capable of delivering 100 kW per channel. Each channel is, for example, a separate 100 kW power channel connected to a respective one of the four battery packs 1602 on the aircraft 2400.

The charger 114 receives AC power from the grid connection 110 and converts it to DC power for charging the aircraft batteries. The charger 114 may provide up to 750 VDC and 130 A of power to charge multiple aircraft concurrently.

Each power channel of the charger 114 is isolated to maintain separation between the battery packs 1602. This isolation enhances safety and redundancy. If one battery pack 1602 cannot be charged, the others can still be serviced.

The power channels are controllable based on commands from the aircraft 2400. The aircraft 2500 aircraft 2900 specifies a charging profile for each battery pack 1602 including the voltage, current, and duration. The ground support equipment 104 adjusts each power channel to provide the requested charging profile for the associated battery pack 1602,

The power channels are bidirectional, allowing them to either charge or discharge the battery packs 1602 When charging, the power channels provide power to the batteries. When discharging, the power channels drain power from the batteries by providing a path to ground. The direction of power flow may be controlled by the aircraft 2400 based on the respective needs of each battery pack 1602 and an overall charging plan of the system controller 202 at the control center 112.

In block 2304, the method 2300 connects a respective power channel of the plurality of isolated power channels to a respective isolated battery pack 1602 of a plurality of battery packs 1602 of the aircraft 2400. Two power channels connect to each battery pack 1602 through the high-voltage pin connections in the electrical connectors 520 in the charge handle 108, providing fully isolated and redundant power connections.

If one power channel fails or cannot charge its associated battery pack 1602, the other can continue servicing that battery pack 1602. This avoids delays in recharging the aircraft 2400 and ensures functioning packs reach full charge. The redundant and isolated power channels provide flexibility in servicing the individual needs of each battery pack 1602 and recharging the aircraft 2400 rapidly.

In block 2306, the method 2300 controls an output of each power channel of the plurality of isolated power channels to charge the connected isolated battery pack 1602 of the plurality of battery packs 2102 of the aircraft 2400. The system controller 202 controls the output of each power channel based on commands from the aircraft 2400. The aircraft 2400 specifies a charging profile for each battery pack 2102 including the voltage, current, and duration, for example.

The system controller 202 adjusts each power channel to provide the requested charging profile for the associated battery pack 1602. The power channels can operate at different levels simultaneously to provide custom charging for each battery pack 1602 based on its needs. Battery packs 1602 that are more depleted can be charged at higher rates, while those closer to full can be charged at lower rates, maximizing the charging for each battery pack 1602 and avoiding overcharging.

The power channels make adjustments on the fly based on new commands from the aircraft 2400. As battery packs 2102 approach full charge, the aircraft 2400 may request lower charging rates to avoid overcharging. The power channels can quickly adjust to the new charging profiles for each battery pack 1602 upon request from the aircraft 2400, allowing for precision control and optimization of the charging process.

The multiple isolated power channels provide redundancy in case one power channel cannot charge its associated battery pack 1602. With multiple isolated power channels, if one fails, the others can continue servicing the remaining packs. This avoids delays in recharging the aircraft 2400 and ensures all functioning packs reach full charge.

The power channels are designed to work together to fully recharge the aircraft 2400 as quickly as possible after each flight by operating simultaneously at commanded levels for each battery pack 2502, reducing total recharge time while maintaining precision control and redundancy. The power channels can operate in either charging or discharging mode as needed for each battery pack 1602. Their ability to quickly switch between charging and discharging based on the aircraft's requests allows for complete management of the battery.

### Example Vehicle Overview

FIG. 24 is a plan view of a VTOL aircraft 2400 according to some examples. The aircraft 2400 includes a fuselage 2402, two wings 2404, an empennage 2406, and propulsion systems 2408 embodied as tiltable rotor assemblies 2410 located in nacelles 2412. The aircraft 2400 includes one or more nonlinear and isolated power sources in the example form of battery packs 2502 embodied in FIG. 24 as nacelle battery packs 2414 and wing battery packs 2416. In the illustrated example, the nacelle battery packs 2414 are located in inboard nacelles 2418, but it will be appreciated that the nacelle battery packs 2414 could be located in other nacelles 2412 forming part of the aircraft 2400. The aircraft 2400 will typically include associated equipment such as an electronic infrastructure, control surfaces, a cooling system, landing gear, and so forth.

The wings 2404 function to generate lift to support the aircraft 2400 during forward flight. The wings 2404 can additionally or alternately function to structurally support the battery packs 2502, battery module 2506 and/or propulsion systems 2408 under the influence of various structural stresses (e.g., aerodynamic forces, gravitational forces, propulsive forces, external point loads, distributed loads, and/or body forces, and so forth).

### Energy Storage System 2500

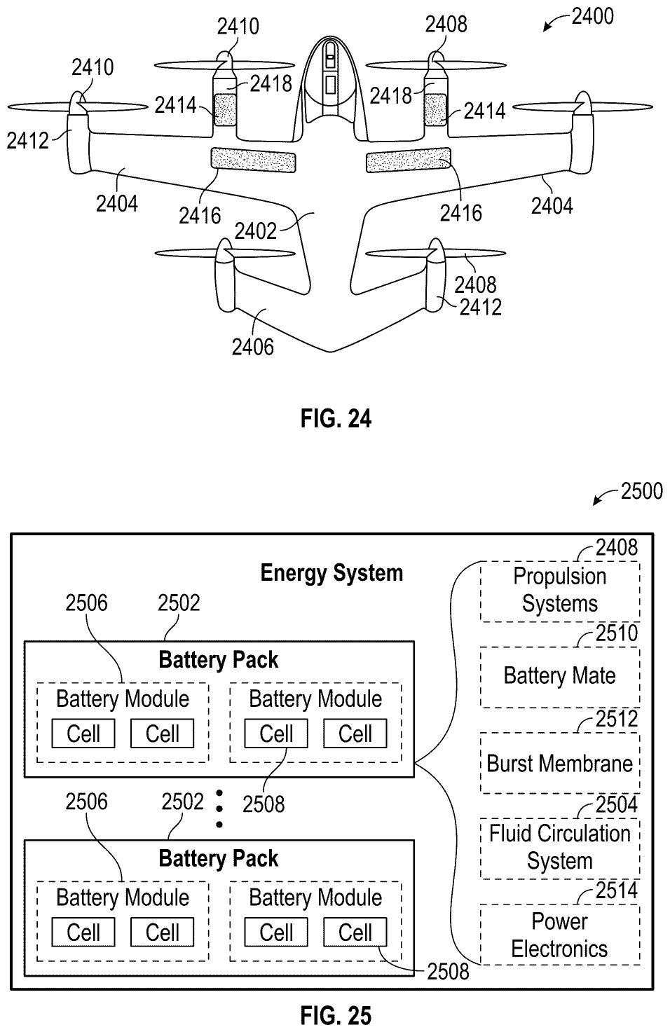

FIG. 25 is a schematic view of an aircraft energy storage system 2500 according to some examples. As shown, the energy storage system 2500 includes one or more battery packs 2502. Each battery pack 2502 may include one or more battery modules 2506, which in turn may comprise a number of cells 2508.

Typically associated with a battery pack 2502 are one or more propulsion systems 2408, a battery mate 2510 for connecting it to the energy storage system 2500, a burst membrane 2512 as part of a venting system, a fluid circulation system 2504 for cooling, and power electronics 2514 for regulating delivery of electrical power (from the battery during operation and to the battery during charging) and to provide integration of the battery pack 2502 with the electronic infrastructure of the energy storage system 2500. As discussed in more detail below, the propulsion systems 2408 may comprise multiple rotor assemblies.

The electronic infrastructure and the power electronics 2514 can additionally or alternately function to integrate the battery packs 2502 into the energy storage system 2500 of the aircraft. The electronic infrastructure can include a Battery Management System (BMS), power electronics (HV architecture, power components, and so forth), LV architecture (e.g., vehicle wire harness, data connections, and so forth), and/or any other suitable components. The electronic infrastructure can include inter-module electrical connections, which can transmit power and/or data between battery packs and/or modules. Inter-modules can include bulkhead connections, bus bars, wire harnessing, and/or any other suitable components.

The battery packs 2502 function to store electrochemical energy in a rechargeable manner for supply to the propulsion systems 2408. Battery packs 2502 can be arranged and/or distributed about the aircraft in any suitable manner. Battery packs can be arranged within wings (e.g., inside of an airfoil cavity), inside nacelles, and/or in any other suitable location on the aircraft. In a specific example, the energy storage system 2500 includes a first battery pack within an inboard portion of a left wing and a second battery pack within an inboard portion of a right wing. In a second specific example, the system includes a first battery pack within an inboard nacelle of a left wing and a second battery pack within an inboard nacelle of a right wing. Battery packs 2502 may include a plurality of battery modules 2506.

The energy storage system 2500 includes a cooling system (e.g., fluid circulation system 2504) that functions to circulate a working fluid within the battery pack 2502 to remove heat generated by the battery pack 2502 during operation or charging. Battery cells 2508, battery module 2506 and/or battery packs 2502 can be fluidly connected by the cooling system in series and/or parallel in any suitable manner.

### Electrical Architecture 2602 for Aircraft 2604

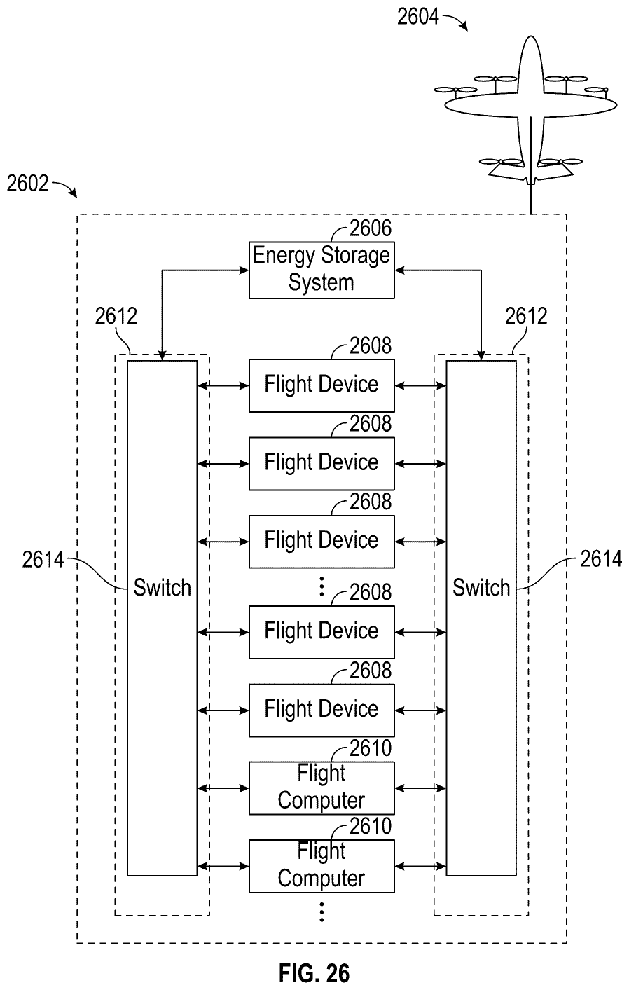

FIG. 26 illustrates an electrical architecture 2602 for the aircraft 2604. The electrical architecture 2602 includes the energy storage system 2606, multiple flight devices 2608, multiple flight computers 2610, and a distribution network 2612. Network 2612 includes a number of switches 2614 and appropriate wired or wireless data-transmission links within the network 2612 and with the other components of the electrical architecture 2602.

The electrical architecture 2602 functions to provide redundant and fault-tolerant power and data connections between the flight device 2608, flight computer 2610 and the energy storage system 2606. The flight devices 2608 can include any components related to aircraft flight, including for example actuators and control surfaces, such as ailerons, flaps, rudder fins, landing gear, sensors (e.g., kinematics sensors, such as IMUs; optical sensors, such as cameras; acoustic sensors, such as microphones and radar; temperature sensors; altimeters; pressure sensors; and/or any other suitable sensor), cabin systems, and so forth.

The flight computers 2610 control the overall functioning of the aircraft 2604, including interpreting and transforming flight data into commands that can be transmitted to and interpreted by controllable flight components. Data may be commands, aircraft state information, and/or any other appropriate data. Aircraft state information may include faults (fault indicator, fault status, fault status information, etc.); sensor readings or information collected by flight components such as speed, altitude, pressure, GPS information, acceleration, user control inputs (e.g., from a pilot or operator), measured motor RPM, radar, images, or other sensor data; component status (e.g., motor controller outputs, sensor status, on/off, etc.), energy storage system 2606 state information (battery pack voltage, level of charge, temperature and so forth); and/or any other appropriate information. Commands may include faults (fault indicator, fault status, fault status information, etc.); control commands (e.g., commanding rotor RPM (or other related parameters such as torque, power, thrust, lift, etc.), data to be stored, commanding a wireless transmission, commanding display output, etc.); and/or any other appropriate information.

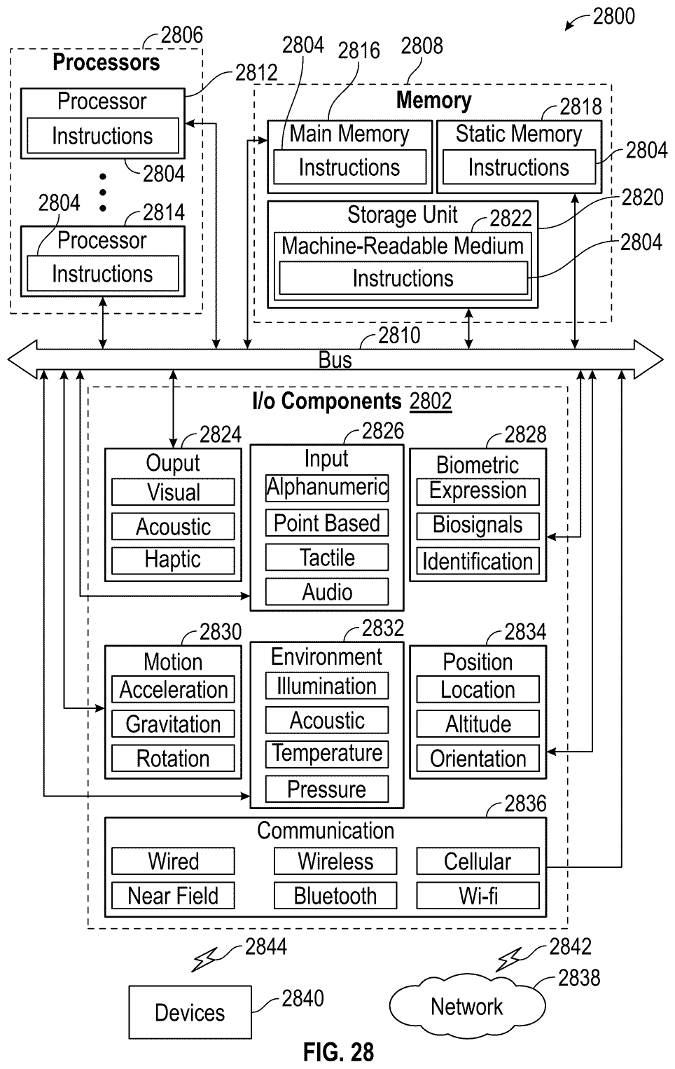

Included with the flight computers 2610 are I/O components 2802 (see FIG. 28) used to receive input from and provide output to a pilot or other operator. I/O components 2802 may for example include a joystick, inceptor, or other flight control input device, data entry devices such as keyboards and touch-input devices, and one or more display screens for providing flight and other information to the pilot or other operator.

One or more of the flight computers 2610 also perform the methods described below for determining the capabilities of the energy storage system 2606, based on data received from the I/O components 2802, data entered by the pilot, data retrieved from one or more remote servers such as the data repository 2702 described below, as well as aircraft and battery state information.

### Computing Environment 2700

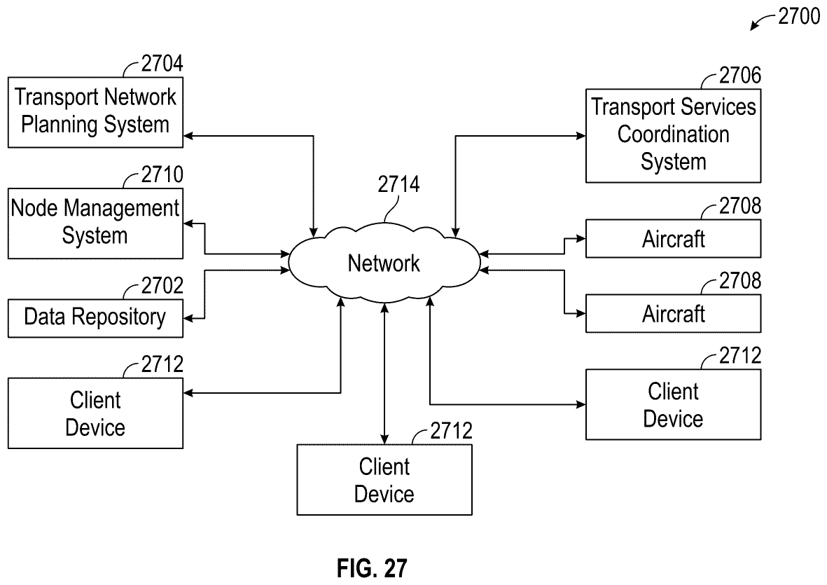

FIG. 27 illustrates a computing environment 2700 associated with an aviation transport network according to some examples. In the example shown in FIG. 4, the computing environment 2700 includes ground support equipment 104 sites, a transport network planning system 2704, a transport services coordination system 2706, a set of aircraft 2708, a node management system 2710 and a set of client devices 2712, all connected via a network 2612. In other examples, the computing environment 2700 contains different and/or additional elements. In addition, the functions may be distributed among the elements in a different manner than described. For example, the node management systems 2710 may be omitted, with information about the nodes stored and updated at the transport network planning system 3204.

The transport network planning system 2704 assists in the planning and design of the transport network. In some examples, the transport network planning system 2704 estimates demand for transport services, suggests locations for transportation nodes to help meet that demand, and simulates the flow of riders and aircraft 2708 between the nodes to assist in network planning.

The transport services coordination system 2706 coordinates transport services once a set of transportation nodes are operational. The transport services coordination system 2706 pairs users who request transport services (riders) with specific aircraft 2708. The transport services coordination system 2706 may also interact with ground-based transportation to coordinate travel services. For example, the transport services coordination system 2706 may be an extension of an existing transport services coordinator, such as a ridesharing service.

The aircraft 2708 are vehicles that fly between nodes (each providing ground support equipment 104) in the transport network. An aircraft 2708 may be controlled by a human pilot (inside the vehicle or on the ground) or it may be autonomous. In some examples, the aircraft 2708 is an aircraft 2400. For convenience, the various components of the computing environment 2700 will be described with reference to this example. However, other types of aircraft may be used, such as helicopters, planes that takeoff at angles other than vertical, and the like.

An aircraft 2708 may include an electrical architecture 2602 that communicates status information (e.g., via the network 2714) to other elements of the computing environment 2700. The status information may include current location, current battery charge, potential component failures, and the like. The electrical architecture 2602 of the aircraft 2708 may also receive information, such as routing information, weather information, and energy availability at nodes where the aircraft is scheduled to be, or currently is, located (e.g., a number of kilowatts that may be drawn from the power grid at a node).

A node management system 2710 provides functionality at a node in the transport network. A node is a location at which aircraft are intended to land and takeoff. Within a transport network, there may be different types of nodes. For example, a node in a central location with a large amount of rider throughput might include sufficient infrastructure for sixteen (or more) aircraft 2708 to simultaneously (or almost simultaneously) take off or land. Similarly, such a node might include multiple charging stations for recharging battery-powered aircraft 2708. In contrast, a node located in a sparely populated suburb might include infrastructure for a single aircraft 2708 and have no charging station. The node management system 2710 may be located at the node or remotely and be connected via the network 2714. In the latter case, a single node management system 2710 may serve multiple nodes.

In some examples, a node management system 2710 monitors the status of equipment at the node and reports to the transport network planning system 2704. For example, if there is a fault in a charging station, the node management system 2710 may automatically report that it is unavailable for charging aircraft 2708 and request maintenance or a replacement. The node management system 2710 may also control equipment at the node. For example, in some examples, a node includes one or more launch pads that may move from a takeoff/landing position to embarking/disembarking position. The node management system 2710 may control the movement of the launch pad (e.g., in response to instructions received from transport services coordination system 2706 and/or an aircraft 2708).

The client devices 2712 are computing devices with which users may arrange transport services within the transport network. In some examples, the client devices 2712 are mobile devices (e.g., smartphones, tablets, and so forth) running an application for arranging transport services. A user provides a pickup location and destination within the application and the client device 2712 sends a request for transport services to the transport services coordination system 2706. Alternatively, the user may provide a destination and the pickup location is determined based on the user's current location (e.g., as determined from GPS data for the client device 2712).

Regardless of how they are generated, the transport services coordination system 2706 determines how to service transport requests. In some examples, a transport request can be serviced by a combination of ground-based and aerial transportation. The transport services coordination system 2706 sends information about how the request will be serviced to the user's client device (e.g., what vehicle the user should get into, directions on where to walk, if necessary, and so forth).

The data repository 2702 includes one or more servers that may or may not be hosted by the provider of the aviation transport network. The data repository 2702 provides information that can be used by the other components of the computing environment 2700, such as weather information at the nodes (barometric pressure, dew point, air temperature, wind direction), geographical information about nodes (elevation, longitude/latitude and so forth) that can be used by the transport network planning system 2704 or the aircraft 2708 for trip planning and for use in determining the capabilities of the energy storage system 2606 as described in more detail below. In some examples the data repository 2702 can be a weather service provider, a provider of mapping or other geographic information, and so forth. The data repository 2702 may also be hosted as part of, or distributed between, other components of the computing environment 2700, such as the transport services coordination system 2706 and the node management system 2710.

The network 2714 provides the communication channels via which the other elements of the networked computing environment 2700 communicate. The network 2714 can include any combination of local area and/or wide area networks, using both wired and/or wireless communication systems.

### Computer System

FIG. 28 shows a diagrammatic representation of the machine 2800 in the example form of a computer system (e.g., the system controller 202, the control center 112, the GSE controller 1608, the flight computer 2610) within which instructions 2804 (e.g., software, a program, an application, an applet, an app, or other executable code) for causing the machine 2800 to perform any one or more of the methodologies discussed herein may be executed. The instructions 2804 may transform the general, non-programmed machine 2800 into a particular machine 2800 programmed to carry out the described and illustrated functions in the manner described. In alternative examples, the machine 2800 operates as a standalone device or may be coupled (e.g., networked) to other machines. In a networked deployment, the machine 2800 may operate in the capacity of a server machine or a client machine in a server-client network environment, or as a peer machine in a peer-to-peer (or distributed) network environment. The machine 2800 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 2804, sequentially or otherwise, that specify actions to be taken by the machine 2800. Further, while only a single machine 2800 is illustrated, the term “machine” shall also be taken to include a collection of machines 2800 that individually or jointly execute the instructions 2804 to perform any one or more of the methodologies discussed herein.

The machine 2800 may include processors 2806, memory 2808, and I/O components 2802, which may be configured to communicate with each other such as via a bus 2810. In an example, the processors 2806 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 2812 and a processor 2814 that may execute the instructions 2804. The term “processor” is intended to include multi-core processors that may comprise two or more independent processors (sometimes referred to as “cores”) that may execute instructions contemporaneously. Although FIG. 28 shows multiple processors 2806, the machine 2800 may include a single processor with a single core, a single processor with multiple cores (e.g., a multi-core processor), multiple processors with a single core, multiple processors with multiples cores, or any combination thereof.

The memory 2808 may include a main memory 2816, a static memory 2818, and a storage unit 2820, both accessible to the processors 2806 such as via the bus 2810. The main memory 2808, the static memory 2818, and storage unit 2820 store the instructions 2804 embodying any one or more of the methodologies or functions described herein. The instructions 2804 may also reside, completely or partially, within the main memory 2816, within the static memory 2818, within machine-readable medium 2822 within the storage unit 2820, within at least one of the processors 2806 (e.g., within the processor's cache memory), or any suitable combination thereof, during execution thereof by the machine 2800.

The I/O components 2802 may include a wide variety of components to receive input, provide output, produce output, transmit information, exchange information, capture measurements, and so on. The specific I/O components 2802 that are included in a particular machine will depend on the type of machine. For example, portable machines such as mobile phones will likely include a touch input device or other such input mechanisms, while a headless server machine will likely not include such a touch input device. It will be appreciated that the I/O components 2802 may include many other components that are not shown in FIG. 28. The I/O components 2802 are grouped according to functionality merely for simplifying the following discussion and the grouping is in no way limiting. In various examples, the I/O components 2802 may include output components 2824 and input components 2826. The output components 2824 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 2826 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further examples, the I/O components 2802 may include biometric components 2828, motion components 2830, environmental components 2832, or position components 2834, among a wide array of other components. For example, the biometric components 2828 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 2830 may include acceleration sensor components (e.g., accelerometer), gravitation sensor components, rotation sensor components (e.g., gyroscope), and so forth. The environmental components 2832 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 2834 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 2802 may include communication components 2836 operable to couple the machine 2800 to a network 2838 or devices 2840 via a coupling 2842 and a coupling 2844, respectively. For example, the communication components 2836 may include a network interface component or another suitable device to interface with the network 2838. In further examples, the communication components 2836 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 2840 may be another machine or any of a wide variety of peripheral devices (e.g., a peripheral device coupled via a USB).

Moreover, the communication components 2836 may detect identifiers or include components operable to detect identifiers. For example, the communication components 2836 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 2836, such as location via Internet Protocol (IP) geolocation, location via Wi-Fi® signal triangulation, location via detecting an NFC beacon signal that may indicate a particular location, and so forth.

### Executable Instructions and Machine Storage Medium

The various memories (i.e., memory 2808, main memory 2816, static memory 2818, and/or memory of the processors 2806) and/or storage unit 2820 may store one or more sets of instructions and data structures (e.g., software) embodying or utilized by any one or more of the methodologies or functions described herein. These instructions (e.g., the instructions 2804), when executed by processors 2806, cause various operations to implement the disclosed examples.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various examples, one or more portions of the network 2838 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 2838 or a portion of the network 2838 may include a wireless or cellular network, and the coupling 2842 may be a Code Division Multiple Access (CDMA) connection, a Global System for Mobile communications (GSM) connection, or another type of cellular or wireless coupling. In this example, the coupling 2842 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 2804 may be transmitted or received over the network 2838 using a transmission medium via a network interface device (e.g., a network interface component included in the communication components 2836) and utilizing any one of a number of well-known transfer protocols (e.g., hypertext transfer protocol (HTTP)). Similarly, the instructions 2804 may be transmitted or received using a transmission medium via the coupling 2844 (e.g., a peer-to-peer coupling) to the devices 2840. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 2804 for execution by the machine 2800, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

### Computer-Readable Medium

The terms “machine-readable medium,” “computer-readable medium” and “device-readable medium” mean the same thing and may be used interchangeably in this disclosure. The terms are defined to include both machine-storage media and transmission media. Thus, the terms include both storage devices/media and carrier waves/modulated data signals.

### Security

As noted above, security, particularly cybersecurity, may be enhanced by the provision of a number of features within the electric aircraft charging environment 102 described above. Examples of such security features may include:
One-Way Data Connections: he electric aircraft charging environment 102, in some examples, implements one-way data connections by only allowing data to flow from the aircraft 2400 to the charging system, and not in the reverse direction. The aircraft data link 412 is coupled to the data offload and interlock 512 of the charge handle 108, and includes two ethernet cables, a 1000BASE-T and a 100BASE-T cable. These data connections are physically isolated from any external networks to prevent unauthorized access. The data connections may be implemented using copper wires or optical fiber cables to prevent electromagnetic interference.
Authentication and Encryption: Authentication and encryption of data transmitted between the aircraft 2400 and ground support equipment 104 is implemented using the aircraft data link 412. This secures sensitive battery, flight and aircraft data from unauthorized access or eavesdropping. Data is encrypted using a 256-bit AES algorithm before being transmitted between the aircraft 2400, the charge handles 108 and charging systems of the ground support equipment 104 Both the aircraft 2400 and charging systems provide authentication keys that match in order to establish a data connection. These keys are provided to authorized personnel only.
Physical Isolation: Physical: Physical isolation of the charging systems networks is, in some examples, achieved by not allowing any external network connections. System components are connected over isolated local data networks, using components like the aircraft data link 412. The local data networks are located in a secured facility with restricted access. Network equipment, including switches, routers, and cabling, is shielded and grounded to prevent electromagnetic interference or tampering. Strict access control procedures are enforced for all personnel accessing the secured facility.
Secured Components: Secured components, including charging system computers (e.g., of the system controller 202), data storage devices, networking equipment and other components within the electric aircraft charging environment 102 have strong access controls and protections such as encryption to prevent unauthorized access. Access is limited to authorized personnel with the necessary security clearances. Secured components may be located within the secured facility. Data on storage devices is encrypted and access may be controlled using multi-factor authentication including ID cards and biometrics. Audits of access and activity are logged for secured components.
Monitoring and Auditing: Monitoring and auditing of the charging system networks of the electric aircraft charging environment 102 may be performed to detect any unauthorized access or tampering. The control center 112 may coordinate charging operations and monitor the ground support equipment 104 systems. Audit logs track access and changes to system data and components so any issues can be identified and addressed quickly. Network monitoring systems track network activity and traffic for signs of intrusion or unauthorized access. Motion sensors, video cameras, and entry/exit logging provide monitoring of the physical secured facility of the ground support equipment 104. Unauthorized physical or network access triggers alerts to security personnel.
Limited Functionality and Access: Limited functionality and access of the charging systems of the ground support equipment 104 includes only providing functionality and access required for charging operations. Unnecessary network connections, software, and access paths that could represent vulnerabilities may be avoided. The charging system computers may further run a customized minimal operating system with essential programs and drivers required for charging operations. Unneeded network ports, accounts, and services are disabled. Role-based access controls restrict users and applications to only the data and system functionality necessary for their roles. Strict change control procedures govern any changes made to the charging system software, configurations or hardware.
Redundancy: Redundancy: Redundancy of charging system data networks and components seeks to remove single points of failure that could be targeted in cyber-attacks. This may include redundant data connections, storage, and networking equipment. The local data networks may be implemented using redundant network switches and cabling paths. Critical data is backed up to redundant storage devices in case of failure. Redundant power supplies and power distribution units provide backup power to all charging system components. Redundant monitoring, security and network equipment help ensure continued operation even if any single component fails or is compromised. Seamless failover and fallback mechanisms deploy backup components as needed while alerting personnel to any failures.

The redundant and isolated design of the ground support equipment 104 seeks to eliminate single points of failure that could impact security or operations. By building redundancy and isolation into the system, the risk of disruption from cyber-attacks, technical failures or unauthorized access can be minimized. Together with stringent security procedures and controls, the ground support equipment 104 is able to maintain high levels of data and system security as required for safe operation.

### EXAMPLES

Example 1 is a charge handle for an electric vehicle, the charge handle comprising: a housing; a core movably accommodated within the housing, the core having a plurality of connectors to operatively engage with a charge port of the electric vehicle; a drive mechanism configured to move the core between a disengaged position and an engaged position relative to the housing; and a latching mechanism configured to secure the housing to the electric vehicle when the core is in the engaged position and to enable release of the charge handle from the electric vehicle when the core is in the disengaged position.

In Example 2, the subject matter of Example 1 includes, wherein the plurality of connectors comprises fluid connectors, electrical connectors, and a data connector.

In Example 3, the subject matter of Example 2 includes, wherein the fluid connectors comprise a coolant in connector and a coolant out connector configured to facilitate circulation of a chilled coolant fluid from a coolant reservoir through the charge handle and into a fluid circulation system of the electric vehicle to thermally manage battery packs of the electric vehicle during charging.

In Example 4, the subject matter of Examples 2-3 includes, wherein the electrical connectors comprise first and second high-voltage connectors configured to facilitate charging of respective first and second isolated battery packs of the electric vehicle.

In Example 5, the subject matter of Examples 2-4 includes, wherein the data connector comprises a data offload and interlock connector configured to facilitate transfer of battery charging data, aircraft telemetry data, and flight data between the electric vehicle and an external controller.

In Example 6, the subject matter of Examples 1-5 includes, wherein the drive mechanism comprises: a helical cam having a cam drive slot defined therein; and a cam follower connected to the core and engaged with the cam drive slot such that rotation of the helical cam moves the core axially between the engaged position and the disengaged position.

In Example 7, the subject matter of Example 6 includes, wherein the helical cam includes a cam lobe configured to engage the latching mechanism when the core is in the disengaged position to release the latching mechanism from the charge port.

In Example 8, the subject matter of Examples 1-7 includes, wherein the latching mechanism comprises one or more pivotable latch arms having a latch tongue to engage with the charge port of the electric vehicle.

In Example 9, the subject matter of Example 8 includes, wherein the one or more pivotable latch arms is biased to a locked position when the core is in the engaged position.

In Example 10, the subject matter of Examples 1-9 includes, visual indicators identifying a position of the core relative to the housing.

In Example 11, the subject matter of Examples 1-10 includes, a control circuitry configured to convert data links.

In Example 12, the subject matter of Examples 1-11 includes, a pressure relief valve in fluid communication with a coolant in channel of the core, wherein the pressure relief valve is configured to open and relieve coolant pressure into a coolant out channel based on pressure in the coolant in channel exceeds a threshold.

In Example 13, the subject matter of Examples 2-12 includes, wherein the plurality of connectors is configured to facilitate sequenced engagement with respective connectors of the plurality of connectors with the electric vehicle.

In Example 14, the subject matter of Example 13 includes, wherein the sequenced engagement begins with a grounding connector followed by fluid, electrical, and data connections.

In Example 15, the subject matter of Example 14 includes, wherein the plurality of connectors is configured with different lengths to facilitate the sequenced engagement with respective connectors of the charge port in an order of: the grounding connector having a first length, the fluid connectors having a second length longer than the first length, the electrical connectors having a third length longer than the second length, and the data connector having a fourth length longer than the third length.

In Example 16, the subject matter of Examples 1-15 includes, a wheel handle connected to the drive mechanism to operate the drive mechanism and enable user control of a core position within the housing.

In Example 17, the subject matter of Example 16 includes, wherein the drive mechanism converts rotation of the wheel handle into linear motion of the core.

In Example 18, the subject matter of Examples 16-17 includes, a locking mechanism on the wheel handle configured to prevent rotation of the wheel handle when the core is in the engaged or disengaged positions.

In Example 19, the subject matter of Examples 1-18 includes, one or more pressure sensors configured to generate pressure data indicating a pressure of a coolant fluid within the charge handle, wherein the pressure data is transmitted to an external controller that controls coolant flow based on the pressure data.

In Example 20, the subject matter of Examples 1-19 includes, a proximal end configured to be coupled to a hose and cable bundle, wherein the proximal end includes coolant in and coolant out spigots for coupling fluid conduits of the hose and cable bundle to coolant in and coolant out channels of the core of the charge handle.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Example 25 is a charge handle for an electric aircraft, the charge handle comprising: a housing; a core slidably accommodated within the housing; a drive mechanism secured within the housing and operationally coupled to the core to drive the core between a disengaged position and an engaged position relative to the housing; and a plurality of connectors secured to and extending from a distal end of the core, the plurality of connectors including fluid connectors, electrical connectors, and a data connector.

In Example 26, the subject matter of Example 25 includes, wherein the drive mechanism comprises a helical cam having a cam drive slot defined therein, and wherein the core comprises a cam follower stud that is accommodated within the cam drive slot and that drives the core between the disengaged position and the engaged position upon rotation of the helical cam.

In Example 27, the subject matter of Example 26 includes, wherein the drive mechanism further comprises a rotation handle coupled to the helical cam to enable rotation of the helical cam by a user.

In Example 28, the subject matter of Examples 25-27 includes, wherein the core is movable by the drive mechanism within the housing between an engaged position, a neutral position, and a disengaged position.

In Example 29, the subject matter of Example 28 includes, wherein, when in the neutral position, the plurality of connectors of the charge handle are disengaged from corresponding connectors of a charge port of the electric aircraft, and the housing is secured to the electric aircraft by a latching mechanism.

In Example 30, the subject matter of Examples 28-29 includes, wherein, when in the disengaged position, the housing is released from the electric aircraft by the latching mechanism.

In Example 31, the subject matter of Examples 25-30 includes, wherein the housing has a first open end through which the plurality of connectors are accessible, and the core is movable between a disengaged position in which the plurality of connectors are disengaged within the housing, and an engaged position in which the plurality of connectors extend through the first open end of the housing.

In Example 32, the subject matter of Example 31 includes, wherein the plurality of connectors extend further from the housing in the engaged position than in the disengaged position.

In Example 33, the subject matter of Examples 31-32 includes, wherein the plurality of connectors are disengaged within the housing in the disengaged position.

In Example 34, the subject matter of Examples 25-33 includes, wherein the housing defines a plurality of windows and the core includes visual indicators that align with the plurality of windows in the engaged position, the disengaged position, and one or more intermediate positions between the engaged position and the disengaged position.

In Example 35, the subject matter of Example 34 includes, wherein the visual indicators provide a visual indication of a degree of extension of the plurality of connectors from the housing.

In Example 36, the subject matter of Examples 25-35 includes, wherein the fluid connectors are longer than the electrical connectors, and the electrical connectors are longer than the data connector so as to facilitate a sequenced engagement and disengagement between the charge handle and a charge port of the electric aircraft.

In Example 37, the subject matter of Examples 25-36 includes, wherein mating positions of the fluid connectors, the electrical connectors, and the data connector facilitate a sequenced engagement and disengagement between the charge handle and a charge port of the electric aircraft.

Example 38 is a charge handle for an electric vehicle, the charge handle comprising: first and second fluid connectors comprising a coolant in connector and a coolant out connector, the fluid connectors to operationally facilitate provision of a coolant fluid from a fluid source external to the electric vehicle to thermally manage the electric vehicle; electrical connectors to operationally facilitate charging of respective first and second isolated battery packs of the electric vehicle from an electric power source external to the electric vehicle; and a data connector to operationally facilitate a transfer of data between the electric vehicle and an external data system.

In Example 39, the subject matter of Example 38 includes, wherein the electrical connectors include first and second high-voltage electrical connectors and a ground connector.

In Example 40, the subject matter of Examples 38-39 includes, wherein the data connector includes a handle data connector and a vehicle data connector.

In Example 41, the subject matter of Examples 38-40 includes, wherein the charging of the respective first and second isolated battery packs of the electric vehicle is a concurrent charge of the respective first and second isolated battery packs of the electric vehicle.

In Example 42, the subject matter of Examples 38-41 includes, a recirculation valve to reduce pressure of flow of the coolant fluid from the coolant in connector to the electric vehicle, wherein the recirculation valve directly couples a fluid flow to the coolant out channel to recirculate the fluid flow within the handle.

In Example 43, the subject matter of Examples 38-42 includes, wherein an engagement and a disengagement by the coolant in connector, the coolant out connector, the electrical connectors, and the data connector to a charge port of the electric vehicle is sequenced during a connection operation.

In Example 44, the subject matter of Example 43 includes, wherein the coolant in connector and the coolant out connector are longer than the electrical connectors, and the electrical connectors are longer than the data connector so as to facilitate the sequenced engagement and disengagement between the charge handle and the charge port of the electric vehicle, the sequenced disengagement between the charge handle and a charge port comprises a first disengagement of the data connector, a second disengagement of the electrical connectors, and a third disengagement of the coolant in connector and the coolant out connector.

In Example 45, the subject matter of Example 44 includes, wherein mating positions of the fluid connectors, the electrical connectors, and the data connector facilitates the sequenced engagement and disengagement between the charge handle and the charge port of the electric aircraft.

The charge handle of Example 38, further comprising: a housing; a core slidably accommodated within the housing, the coolant in connector, the coolant out connector, the electrical connectors, and the data connector secured to and extending from a distal end of the core, and the core being movable between a disengaged position in which the coolant in connector, the coolant out connector, the electrical connectors and the data connector is disengaged within the charge handle, and an engaged position in which the coolant in connector, the coolant out connector, the electrical connectors, and the data connector extend relative to the charge handle; and a drive mechanism secured to the housing and to operationally drive the core between the disengaged position and the engaged position.

In Example 46, wherein the drive mechanism comprises a helical cam having a cam drive slot defined therein, and wherein the core comprises a cam follower stud that is accommodated within the cam drive slot and that drives the core between the disengaged position and the engaged position upon rotation of the helical cam.

In Example 47, the subject matter of Example 46 includes, wherein the drive mechanism further comprises a rotation handle to enable rotation of the helical cam by a user.

In Example 48, including a latching mechanism to secure the housing to a charge port of the electric vehicle during engagement of the charge handle with the charge port.

In Example 49, the subject matter of Example 48 includes, wherein the latching mechanism prevents accidental disconnect.

In Example 50, the subject matter of Examples 48-49 includes, wherein the latching mechanism engages with a camming mechanism to secure the housing to the electric vehicle when the core is in the engaged position and to release the charge handle from the engagement with the electric vehicle when the core is in the disengaged position.

In Example 51, the subject matter of Example 50 includes, wherein the camming mechanism comprises a pivoting latch having a cam follower, and a cam lobe that forms part of the camming mechanism that engages the pivoting latch to pivot between a locked position and a release position.

In Example 52, the subject matter of Examples 48-51 includes, wherein the housing defines a plurality of windows to provide views of the core and the drive mechanism within the housing, and where the core and the drive mechanism include a plurality of visual indicators that align with the plurality of windows in a plurality of positions of the core within the housing, thereby providing a visual indication of the plurality of positions.

In Example 53, the subject matter of Example 52 includes, wherein the plurality of visual indicators comprise a ring of the drive mechanism that is visible within the housing, and that provides an indication of a degree of rotation of the drive mechanism within the housing.

In Example 54, the subject matter of Examples 52-53 includes, wherein the plurality of positions of the core within the housing include an engaged position, a neutral position, and a disengaged position.

In Example 55, the subject matter of Example 54 includes, wherein, in the neutral position, the coolant in connector, the coolant out connector, the electrical connectors, and the data connector of the charge handle are disengaged from corresponding connectors of a charge port, and the housing is secured to the electric vehicle by the latching mechanism.

In Example 56, the subject matter of Examples 54-55 includes, wherein, in the disengaged position, the housing is released from the electric vehicle by the latching mechanism.

In Example 57, the subject matter of Examples 38-56 includes, wherein the coolant fluid is provisioned to the electric vehicle to thermally manage the electric vehicle during charging of batteries of the electric vehicle.

In Example 58, the subject matter of Example 57 includes, wherein the charge handle includes a first fluid channel to convey the coolant fluid from the coolant in connector to the electric vehicle and a second fluid channel to convey the coolant fluid from the electric vehicle to the coolant out connector.

In Example 59, the subject matter of Example 58 includes, wherein the charge handle includes a recirculation valve fluidly coupled between the first and second fluid channels to recirculate the coolant fluid within the charge handle.

In Example 60, the subject matter of Examples 38-59 includes, wherein the charge handle includes a first power conduit to convey charge from a first high-voltage electrical connector to the first isolated battery pack and a second power conduit to convey charge from a second high-voltage electrical connector to the second isolated battery pack.

In Example 61, the subject matter of Example 60 includes, wherein the first and second power conduits are isolated from each other within the charge handle.

In Example 62, the subject matter of Examples 38-61 includes, wherein the charge handle includes a data conduit to convey data between the data connector and a printed circuit board assembly that includes a field-programmable gate array to manage data transfer between the data connector and the external data system.

In Example 63, the subject matter of Example 62 includes, wherein the printed circuit board assembly converts a first data format received from the data connector to a second data format for transmission to the external data system.

In Example 64, the subject matter of Examples 62-63 includes, wherein the charge handle further includes a pressure sensor to sense a pressure of the coolant fluid, the pressure sensor being electrically coupled to the printed circuit board assembly.

In Example 65, the subject matter of Example 64 includes, wherein the printed circuit board assembly receives pressure data from the pressure sensor and includes the pressure data in the data transmitted to the external data system.

In Example 66, the subject matter of Example 65 includes, wherein the external data system controls a flow rate of the coolant fluid based on the pressure data to maintain the pressure of the coolant fluid within a predetermined range.

In Example 67, the subject matter of Example 66 includes, wherein the predetermined range is selected to determine a heat transfer rate from the electric vehicle to the coolant fluid.

In Example 68, the subject matter of Example 67 includes, wherein the printed circuit board assembly controls a pump, in response to commands from the external data system, to increase or decrease the flow rate of the coolant fluid.

In Example 69, the subject matter of Example 68 includes, wherein the pump is fluidly coupled between the coolant in connector and the first fluid conduit to pump the coolant fluid into the first fluid conduit.

In Example 70, the subject matter of Example 69 includes, wherein the printed circuit board assembly cuts off the flow of coolant fluid in response to the pressure sensor sensing that the pressure of the coolant fluid has exceeded a maximum threshold pressure.

In Example 71, the subject matter of Example 70 includes, wherein the printed circuit board assembly re-initiates the flow of coolant fluid once the pressure sensor senses that the pressure of the coolant fluid has decreased below the maximum threshold pressure.

In Example 72, the subject matter of Example 71 includes, wherein the maximum threshold pressure is selected to prevent damage to the electric vehicle from over-pressurization of the coolant fluid 49 is missing parent:

Example 73: A charge handle for an electric aircraft, the charge handle comprising: a housing; a core slidably accommodated within the housing; a drive mechanism secured within the housing and operationally coupled to the core to drive the core between a disengaged position and an engaged position; a plurality of connectors secured to and extending from a distal end of the core, the plurality of connectors including fluid connectors to facilitate a flow of coolant between the charge handle and the electric aircraft; and one or more pressure sensors to sense pressure of the coolant within the charge handle, the one or more pressure sensors providing pressure data to a system controller.

In Example 73, wherein the one or more pressure sensors sense the pressure of the coolant within the fluid channels of the charge handle.

In Example 74, wherein the one or more pressure sensors sense the pressure of the coolant at one or more locations between the fluid connectors and a coolant source external to the electric aircraft.

In Example 75, wherein the system controller controls a flow of the coolant based at least in part on the pressure data from the one or more pressure sensors.

In Example 76, the subject matter of Example 75 includes, wherein the system controller reduces or stops the flow of the coolant based on the pressure data indicating the pressure of the coolant exceeds a threshold pressure.

In Example 77, wherein the system controller monitors the pressure data from the one or more pressure sensors to detect blockages of a flow of the coolant.

In Example 78, wherein the system controller provides an alert to an operator based the pressure data from the one or more pressure sensors is outside of a normal operating range.

In Example 79, wherein the one or more pressure sensors are in communication with the system controller via a wired or wireless data connection.

In Example 80, wherein the one or more pressure sensors are powered by a power source within the charge handle.

In Example 81, wherein the one or more pressure sensors are mounted within a wall of the core.

In Example 82, wherein the one or more pressure sensors extend into a flow path of the coolant.

Example 83 is a ground support equipment for an electric aircraft having isolated battery packs, the ground support equipment comprising: a plurality of isolated power modules to convey electrical charge to the isolated battery packs, each power module comprising an isolated power channel; a thermal management system to provide a cooling medium; and a control system to govern operations of the power modules and the thermal management system.

In Example 84, the subject matter of Example 83 includes, wherein each power module is configured to convert alternating current power to direct current power.

In Example 85, the subject matter of Examples 83-84 includes, wherein the thermal management system comprises: a cooling system to reduce the temperature of the cooling medium; a reservoir system to store the cooled cooling medium; and a pumping system to propel the cooled cooling medium.

In Example 86, the subject matter of Examples 83-85 includes, wherein the control system coordinates the conveyance of charge to the isolated battery packs.

In Example 87, the subject matter of Examples 83-86 includes, wherein the control system monitors the power modules, the thermal management system and indicates anomalies to operators.

In Example 88, the subject matter of Examples 83-87 includes, wherein each isolated power channel is connected to a respective isolated battery pack.

In Example 89, the subject matter of Examples 83-88 includes, wherein each power module comprises an alternating current power supply.

In Example 90, the subject matter of Examples 83-89 includes, wherein the control system conveys data from the power modules and the thermal management system to a command center.

In Example 91, wherein the reservoir system retains a cooling medium solution.

In Example 92, the subject matter of Examples 83-91 includes, wherein the electric aircraft is a vertical take-off and landing vehicle.

In Example 93, the subject matter of Examples 83-92 includes, wherein the thermal management system reduces the temperature of the isolated battery packs.

In Example 94, the subject matter of Examples 83-93 includes, wherein the control system governs the conveyance of charge to the isolated battery packs based on requests received from the electric aircraft.

In Example 95, the subject matter of Examples 83-94 includes, wherein each power module is galvanically isolated from each other power module.

In Example 96, the subject matter of Examples 83-95 includes, wherein each power module is controllable based on commands from the aircraft.

In Example 97, the subject matter of Examples 83-96 includes, wherein each power module is bidirectional, allowing the power modules to at least one of convey charge to and drain charge from the isolated battery packs.

In Example 98, the subject matter of Examples 83-97 includes, wherein the power modules can operate in charging mode, discharging mode or a combination thereof for each battery pack based on requirements of each battery pack.

In Example 99, the subject matter of Examples 83-98 includes, wherein the power modules can simultaneously convey charge to each of the isolated battery packs at or near their maximum rates, thereby reducing total recharge time.

In Example 100, the subject matter of Examples 83-99 includes, wherein the power modules provide different charging profiles to each battery pack based on commands from the aircraft.

In Example 101, the subject matter of Examples 83-100 includes, wherein the power modules make adjustments dynamically based on commands from the aircraft.

In Example 102, the subject matter of Examples 83-101 includes, wherein the power modules are transitionable between charging and discharging modes to provide governance over the state of charge of the battery packs.

In Example 103, the subject matter of Examples 83-102 includes, wherein the power modules function cohesively based on inputs from the aircraft to recharge the aircraft.

In Example 104, the subject matter of Examples 83-103 includes, wherein the power modules allow for simultaneous conveyance of charge to or draining of charge from the isolated battery packs.

In Example 105, the subject matter of Examples 83-104 includes, wherein the control system controls the conveyance of charge to the isolated battery packs and the temperature of the cooling medium based on requests received from the electric aircraft.

In Example 106, the subject matter of Examples 83-105 includes, wherein the control system transmits data from the power modules and the thermal management system to a remote command system.

In Example 107, wherein the reservoir system retains a mixture of cooling media.

In Example 108, the subject matter of Examples 83-107 includes, wherein the control system records details of each charging and thermal control event.

In Example 109, the subject matter of Examples 83-108 includes, wherein the power modules provide excess capacity in case one power module cannot convey charge to its associated battery pack.

In Example 110, the subject matter of Examples 83-109 includes, wherein the power modules adjust outputs dynamically based on commands from the aircraft.

In Example 111, the subject matter of Examples 83-110 includes, wherein the power modules can switch seamlessly between charging and discharging modes for each battery pack based on commands from the aircraft.

Example 112 is a method of operating a charge handle for an electric aircraft, the method comprising: engaging, by the charge handle, a grounding connector of the charge handle with a corresponding grounding connector of a charge port of the electric aircraft; engaging, by the charge handle, one or more fluid connectors of the charge handle with corresponding one or more fluid connectors of the charge port after engaging the grounding connector; engaging, by the charge handle, one or more electrical connectors of the charge handle with corresponding one or more electrical connectors of the charge port after engaging the one or more fluid connectors; and engaging, by the charge handle, a data connector of the charge handle with a corresponding data connector of the charge port after engaging the one or more electrical connectors.

In Example 113, the subject matter of Example 112 includes, disengaging, by the charge handle, the data connector from the corresponding data connector of the charge port; disengaging, by the charge handle, the one or more electrical connectors from the corresponding one or more electrical connectors of the charge port after disengaging the data connector; disengaging, by the charge handle, the one or more fluid connectors from the corresponding one or more fluid connectors of the charge port after disengaging the one or more electrical connectors; and disengaging, by the charge handle, the grounding connector from the corresponding grounding connector of the charge port after disengaging the one or more fluid connectors.

In Example 114, the subject matter of Examples 112-113 includes, wherein the one or more fluid connectors are engaged before the one or more electrical connectors to enable a flow of coolant before energizing electrical systems.

In Example 115, the subject matter of Examples 112-114 includes, wherein the data connector is engaged after the one or more electrical connectors to avoid data transfer before electrical connections are grounded.

In Example 116, the subject matter of Examples 112-115 includes, wherein the grounding connector is engaged first to discharge any static buildup.

In Example 117, the subject matter of Examples 113-116 includes, wherein the data connector is disengaged first to cut off data transfer.

In Example 118, the subject matter of Examples 113-117 includes, wherein the one or more electrical connectors are disengaged after the data connector cuts off power.

In Example 119, the subject matter of Examples 113-118 includes, wherein the one or more fluid connectors are disengaged after the one or more electrical connectors cut off coolant flow.

In Example 120, the subject matter of Examples 113-119 includes, wherein the grounding connector is disengaged last to avoid arcing.

Example 121 is a method of operating a charge handle for an electric aircraft, the method comprising: providing, via fluid connectors of a charge handle, a fluid from a fluid source external to the electric aircraft to thermally manage the electric aircraft; providing, via electrical connectors of the charge handle, charging of respective first and second isolated battery packs of the electric aircraft from an electric source external to the electric aircraft; and facilitating, via a data connector of the charge handle, a transfer of data between the electric aircraft and an external data system.

In Example 122, the subject matter of Example 121 includes, wherein the electrical connectors include first and second high-voltage electrical connectors and a ground connector.

In Example 123, the subject matter of Examples 121-122 includes, wherein the data includes a handle data connector and an aircraft data connector.

In Example 124, the subject matter of Examples 121-123 includes, wherein the charging of the respective first and second isolated battery packs of the electric aircraft is a concurrent charging of the respective first and second isolated battery packs of the electric aircraft.

In Example 125, the subject matter of Examples 121-124 includes, reducing, by a recirculation valve, pressure of fluid flow from the first fluid connector to the electric aircraft, wherein the recirculation valve directly couples a fluid flow to the second fluid connector to recirculate the fluid flow within the handle.

In Example 126, the subject matter of Examples 121-125 includes, sequencing an engagement and a disengagement by the fluid connectors, the electrical connectors, and the data connector to a charge port of the electric aircraft during a connection operation.

In Example 127, the subject matter of Example 126 includes, wherein the fluid connectors are longer than the electrical connectors, and the electrical connectors are longer than the data connector so as to facilitate the sequenced engagement and disengagement between the charge handle and the charge port of the electric aircraft, the sequenced disengagement between the charge handle and a charge port comprises a first disengagement of the data connector, a second disengagement of the electrical connectors, and a third disengagement of the fluid connectors.

In Example 128, the subject matter of Examples 126-127 includes, wherein mating positions of the fluid connectors, the electrical connectors, and the data connector facilitates the sequenced engagement and disengagement between the charge handle and the charge port of the electric aircraft.

In Example 129, the subject matter of Examples 121-128 includes, driving, by a drive mechanism, a core between a disengaged position and an engaged position, wherein the fluid connectors, the electrical connectors, and the data connector are secured to and extend from a distal end of the core.

In Example 130, the subject matter of Example 129 includes, securing, by a latching mechanism, a housing to a charge port of the electric aircraft during engagement of the charge handle with the charge port.

In Example 131, the subject matter of Example 130 includes, wherein the latching mechanism is to prevent accidental disconnect.

In Example 132, the subject matter of Examples 130-131 includes, wherein the latching mechanism engages with a camming mechanism to secure the housing to the electric aircraft when the core is in the engaged position and to release the charge handle from the engagement with the electric aircraft when the core is in the disengaged position.

In Example 133, the subject matter of Examples 121-132 includes, wherein the fluid is a coolant fluid that is provisioned to the electric aircraft to thermally manage the electric aircraft during charging of batteries of the electric aircraft.

In Example 134, the subject matter of Examples 121-133 includes, wherein the first and second fluid connectors each comprise a dry break coupler.

Example 135 is a method of operating a charge handle for an electric aircraft, the method comprising: securing a housing of the charge handle to a charge port of the electric aircraft using a latching mechanism; driving a core within the housing between a disengaged position and an engaged position; and extending fluid connectors, electrical connectors, and a data connector from a distal end of the core.

In Example 136, the subject matter of Example 135 includes, engaging, by the charge handle, the fluid connectors, the electrical connectors, and the data connector with corresponding connectors of the charge port when the core is in the engaged position.

In Example 137, the subject matter of Example 136 includes, engaging the fluid connectors with corresponding fluid connectors of the charge port before engaging the electrical connectors with corresponding electrical connectors of the charge port.

In Example 138, the subject matter of Example 137 includes, engaging the electrical connectors with corresponding electrical connectors of the charge port before engaging the data connector with a corresponding data connector of the charge port.

In Example 139, the subject matter of Examples 135-138 includes, disengaging, by the charge handle, the data connector from a corresponding data connector of the charge port when moving the core from the engaged position towards the disengaged position.

In Example 140, the subject matter of Example 139 includes, disengaging, by the charge handle, the electrical connectors from corresponding electrical connectors of the charge port after disengaging the data connector when moving the core further towards the disengaged position.

In Example 141, the subject matter of Example 140 includes, disengaging, by the charge handle, the fluid connectors from corresponding fluid connectors of the charge port after disengaging the electrical connectors when moving the core further towards the disengaged position.

In Example 142, the subject matter of Examples 135-141 includes, driving the core between the disengaged position and the engaged position by rotating a helical cam having a cam drive slot defined therein, wherein the core comprises a cam follower stud accommodated within the cam drive slot.

In Example 143, the subject matter of Example 142 includes, rotating, by a rotation handle, the helical cam to drive the core from the disengaged position to the engaged position.

In Example 144, the subject matter of Example 143 includes, rotating, by the rotation handle, the helical cam to drive the core from the engaged position to the disengaged position.

In Example 145, the subject matter of Examples 135-144 includes, defining a plurality of windows in the housing; and including visual indicators on the core that align with the plurality of windows in the engaged position, the disengaged position, and one or more intermediate positions between the engaged position and the disengaged position.

In Example 146, the subject matter of Example 145 includes, wherein the visual indicators provide a visual indication of a degree of extension of the connectors from the housing.

In Example 147, the subject matter of Examples 135-146 includes, extending the fluid connectors, the electrical connectors, and the data connector further from the housing in the engaged position than in the disengaged position.

In Example 148, the subject matter of Examples 135-147 includes, retracting the fluid connectors, the electrical connectors, and the data connector within the housing in the disengaged position.

In Example 149, the subject matter of Examples 135-148 includes, engaging the latching mechanism with a camming mechanism to secure the housing to the electric aircraft when the core is in the engaged position; and releasing the charge handle from engagement with the electric aircraft using the latching mechanism when the core is in the disengaged position.

In Example 150, the subject matter of Example 149 includes, wherein the camming mechanism comprises a pivoting latch, and further comprising: providing an inward-facing surface on the pivoting latch that acts as a cam follower; and engaging a cam lobe with the cam follower to pivot the latch between a locked position and a release position.

In Example 151, the subject matter of Example 150 includes, carrying the cam lobe by a cam ring secured to an inner edge of a helical cam of the drive mechanism.

In Example 152, the subject matter of Examples 150-151 includes, engaging the cam lobe with the cam follower to pivot the latch to the locked position when the core is in the engaged position.

In Example 153, the subject matter of Examples 150-152 includes, engaging the cam lobe with the cam follower to pivot the latch to the release position when the core is in the disengaged position.

In Example 154, further comprising: providing a tongue at a free end of the latch that engages with a retention slot defined within the charge port when the latch is in the locked position.

In Example 155, the subject matter of Example 154 includes, locating the tongue against the housing when the latch is in the release position.

In Example 156, the subject matter of Examples 154-155 includes, pivoting the latch around a fulcrum using the camming mechanism to push the tongue into engagement with the retention slot when driving the core to the engaged position.

In Example 157, further comprising: causing rotation of the helical cam by a user turning a rotation handle of the drive mechanism to actuate the camming mechanism.

In Example 158, the subject matter of Examples 149-157 includes, wherein the charge port is located in a wing of the aircraft, and further comprising: locking the latch to the charge port such that a force applied by an operator to engage the connectors is reacted against a chassis of the aircraft.

In Example 159, the subject matter of Example 158 includes, wherein locking the latch prevents the operator from pushing up on the wing during engagement of the connectors.

In Example 160, the subject matter of Examples 149-159 includes, wherein the latch prevents accidental disconnect of the charge handle from the charge port during engagement of the connectors.

In Example 161, the subject matter of Examples 149-160 includes, wherein the latch provides a safety mechanism to avoid destabilizing the aircraft during connection of the charge handle to the charge port.

In Example 162, the subject matter of Examples 135-161 includes, wherein the fluid connectors are longer than the electrical connectors, and the electrical connectors are longer than the data connector so as to facilitate a sequenced engagement and disengagement between the charge handle and the charge port of the electric aircraft.

In Example 163, the subject matter of Examples 135-162 includes, wherein mating positions of the fluid connectors, the electrical connectors, and the data connector facilitate a sequenced engagement and disengagement between the charge handle and the charge port of the electric aircraft.

In Example 164, the subject matter of Examples 135-163 includes, wherein the drive mechanism comprises a helical cam having a cam drive slot defined therein, and wherein the core comprises a cam follower stud that is accommodated within the cam drive slot and that drives the core between the disengaged position and the engaged position upon rotation of the helical cam.

In Example 165, the subject matter of Example 164 includes, wherein the drive mechanism further comprises a rotation handle to enable rotation of the helical cam by a user.

In Example 166, the subject matter of Examples 135-165 includes, wherein the latching mechanism engages with a camming mechanism to secure the housing to the electric aircraft when the core is in the engaged position and to release the charge handle from the engagement with the electric aircraft when the core is in the disengaged position.

In Example 167, the subject matter of Example 166 includes, wherein the camming mechanism comprises a pivoting latch having an inward-facing surface that acts as a cam follower, and a cam lobe that engages the cam follower to pivot the latch between a locked position and a release position.

In Example 168, the subject matter of Example 167 includes, wherein the cam lobe is carried by a cam ring secured to an inner edge of the helical cam.

In Example 169, the subject matter of Examples 167-168 includes, wherein the cam lobe engages the cam follower to pivot the latch to the locked position when the core is in the engaged position.

In Example 170, the subject matter of Examples 167-169 includes, wherein the cam lobe engages the cam follower to pivot the latch to the release position when the core is in the disengaged position.

In Example 171, the subject matter of Examples 166-170 includes, wherein the latch has a tongue at a free end thereof that engages with a retention slot defined within the charge port when the latch is in the locked position.

In Example 172, the subject matter of Example 171 includes, wherein the tongue is located against the housing when the latch is in the release position.

In Example 173, the subject matter of Examples 171-172 includes, wherein the camming mechanism pivots the latch around a fulcrum to push the tongue into engagement with the retention slot when driving the core to the engaged position.

In Example 174, the subject matter of Example 173 includes, wherein a user turning the rotation handle causes rotation of the helical cam to actuate the camming mechanism.

Example 175 is a method of charging isolated battery packs of a vehicle, the method comprising: providing a charger comprising a plurality of isolated power channels; connecting a respective power channel of the plurality of isolated power channels to a respective isolated battery pack of a plurality of battery packs of the vehicle; and controlling an output of each power channel of the plurality of isolated power channels to charge the connected isolated battery pack of the plurality of battery packs of the vehicle.

In Example 176, the subject matter of Example 175 includes, wherein the controlling comprises adjusting the output of each power channel based on a state of charge of the connected isolated battery pack.

In Example 177, the subject matter of Examples 175-176 includes, wherein the controlling comprises adjusting the output of each power channel based on a maximum charge rate of the connected isolated battery pack.

In Example 178, the subject matter of Examples 175-177 includes, wherein the vehicle is an electric aircraft.

In Example 179, the subject matter of Example 178 includes, receiving data from one or more pressure sensors; and controlling a cooling system for the electric aircraft based on the data from the one or more pressure sensors.

In Example 180, the subject matter of Example 179 includes, wherein the one or more pressure sensors sense a pressure of a coolant used to cool the isolated battery packs.

In Example 181, the subject matter of Example 180 includes, wherein the cooling system comprises a chiller to chill the coolant and a pump to pump the chilled coolant.

In Example 182, the subject matter of Example 181 includes, controlling at least one of a speed of the pump and a temperature of the chiller based on the data from the one or more pressure sensors.

In Example 183, the subject matter of Examples 179-182 includes, wherein the one or more pressure sensors communicate with a system controller via a charge handle coupled between the vehicle and a ground support equipment.

In Example 184, the subject matter of Example 183 includes, wherein the charge handle converts a first data format from the one or more pressure sensors to a second data format for communication with the system controller.

In Example 185, the subject matter of Examples 175-184 includes, encrypting data communicated between a system controller and at least one of a charge handle and the vehicle.

In Example 186, the subject matter of Examples 175-185 includes, wherein the charger receives AC power and converts the AC power to DC power for charging the isolated battery packs.

In Example 187, the subject matter of Examples 175-186 includes, wherein the charger has a high-voltage AC power supply.

In Example 188, the subject matter of Examples 175-187 includes, wherein the system controller coordinates charging of the isolated battery packs.

In Example 189, the subject matter of Examples 175-188 includes, wherein the system controller provides data from the charger to a control center.

In Example 190, the subject matter of Examples 179-189 includes, wherein the cooling system provides coolant to the charge handle, which flows into an internal cooling system of the electric aircraft.

In Example 191, the subject matter of Example 190 includes, wherein the coolant is returned from the electric aircraft to the cooling system.

In Example 192, the subject matter of Examples 175-191 includes, wherein a system controller sends a signal to a charge handle to start data offload from the electric aircraft.

In Example 193, the subject matter of Example 192 includes, wherein the system controller monitors a status of the data offload and provides an alert to an operator if the data offload does not complete within a predetermined time period.

In Example 194, the subject matter of Examples 192-193 includes, wherein the charge handle encrypts the data offloaded from the electric aircraft before transmitting the data to the system controller.

In Example 195, the subject matter of Example 194 includes, wherein the system controller authenticates the charge handle prior to enabling charging of the electric aircraft.

In Example 196, the subject matter of Examples 194-195 includes, wherein the system controller monitors communications from the charge handle for signs of unauthorized access or interference.

In Example 197, the subject matter of Example 196 includes, wherein the system controller disables charging in response to detecting unauthorized access or interference in communications from the charge handle.

In Example 198, the subject matter of Examples 194-197 includes, wherein the charge handle monitors communications from the system controller for signs of unauthorized access or interference.

In Example 199, the subject matter of Example 198 includes, wherein the charge handle disables at least one of a flow of coolant and a flow of charge to the electric aircraft in response to detecting unauthorized access or interference in communications from the system controller.

Example 200 is a method of operating ground support equipment for an electric vehicle, the method comprising: receiving, by the ground support equipment, a first signal from a charge handle coupled between the electric vehicle and the ground support equipment; initiating, by the ground support equipment, one or more battery chargers and one or more coolant pumps in response to the first signal to provide power and cooling to the electric vehicle; transmitting, by the ground support equipment, a second signal to the charge handle to start data offload from the electric vehicle; receiving, by the ground support equipment, flight data, telemetry data, and pressure data from the charge handle, the flight data, the telemetry data, and the pressure data being in an Ethernet format; and controlling, by a system controller of the ground support equipment, the one or more battery chargers and the one or more coolant pumps based at least in part on the pressure data.

In Example 201, the subject matter of Example 200 includes, wherein the controlling comprises the system controller adjusting an output of each battery charger based on a state of charge of a battery pack connected to the battery charger.

In Example 202, the subject matter of Examples 200-201 includes, wherein the controlling comprises the system controller adjusting a speed of each coolant pump based on the pressure data.

In Example 203, the subject matter of Examples 200-202 includes, the system controller recording details of a charging session for the electric vehicle.

In Example 204, the subject matter of Examples 200-203 includes, the system controller monitoring the charge handle for changes to software or configurations of the charge handle.

In Example 205, the subject matter of Examples 200-204 includes, wherein the system controller coordinates charging of multiple battery packs of the electric vehicle.

In Example 206, the subject matter of Examples 200-205 includes, wherein the ground support equipment receives firmware from a control center.

In Example 207, the subject matter of Examples 200-206 includes, wherein the ground support equipment provides data to a control center.

In Example 208, the subject matter of Examples 200-207 includes, wherein the controlling comprises the system controller controlling each of a plurality of isolated power supplies to control charging of respective connected battery packs of the electric vehicle.

In Example 209, the subject matter of Example 208 includes, wherein the system controller accesses charging profiles for each connected battery pack, each charging profile specifying at least one of a target voltage, a target current, or a charging rate for the connected battery pack.

In Example 210, the subject matter of Example 209 includes, wherein the system controller adjusts an output of each isolated power supply based on the charging profile for the connected battery pack.

In Example 211, the subject matter of Example 210 includes, wherein the system controller adjusts the output of each isolated power supply based on a state of charge of the connected battery pack.

In Example 212, the subject matter of Example 211 includes, wherein the system controller determines the state of charge of each connected battery pack based at least in part on data received from the charge handle.

In Example 213, the subject matter of Example 212 includes, wherein the data received from the charge handle includes at least one of voltage data, current data, or temperature data for each connected battery pack.

In Example 214, the subject matter of Examples 208-213 includes, wherein each isolated power supply is connected to a respective battery pack of the electric vehicle to maintain separation between the battery packs.

In Example 215, the subject matter of Example 214 includes, wherein if one isolated power supply cannot charge its connected battery pack, the remaining isolated power supplies continue charging their connected battery packs.

In Example 216, the subject matter of Examples 208-215 includes, wherein each isolated power supply is controllable based on commands from the system controller to provide a desired charging profile for the connected battery pack.

In Example 217, the subject matter of Example 216 includes, wherein each isolated power supply adjusts at least one of a voltage and a current provided to the connected battery pack based on the commands from the system controller.

In Example 218, the subject matter of Examples 208-217 includes, wherein each isolated power supply is bidirectional, allowing the system controller to control the isolated power supply to either charge or discharge the connected battery pack.

In Example 219, the subject matter of Example 218 includes, wherein the system controller controls an operating mode of each isolated power supply based on data received from the charge handle regarding a state of charge of each connected battery pack.

Example 220 is at least one machine-readable medium including instructions that, when executed by processing circuitry, cause the processing circuitry to perform operations to implement of any of Examples 25-219.

Example 221 is an apparatus comprising means to implement of any of Examples 25-219.

Example 222 is a system to implement of any of Examples 25-219.

Example 223 is a method to implement of any of Examples 25-219.

What is claimed is:

1. A charge handle for an electric aircraft, comprising:
a housing;
a core slidably accommodated within the housing;
a coolant flow path within the core;
a plurality of pressure sensors located within the core to detect pressure within the coolant flow path; and
a communication interface to transmit pressure data from the plurality of pressure sensors, enabling control of coolant flow based on the transmitted pressure data.

2. The charge handle of claim 1, wherein the plurality of pressure sensors comprises at least two pressure sensors.

3. The charge handle of claim 1, wherein the coolant flow path within the core includes a coolant in chamber and a coolant out chamber, and wherein the plurality of pressure sensors comprises a first pressure sensor located to detect pressure in the coolant in chamber and a second pressure sensor located to detect pressure in the coolant out chamber.

4. The charge handle of claim 1, further comprising a printed circuit board assembly configured to process the pressure data before transmission through the communication interface.

5. The charge handle of claim 4, wherein the printed circuit board assembly is configured to convert data from the plurality of pressure sensors from a first format to a second format.

6. The charge handle of claim 4, wherein the printed circuit board assembly is configured to transmit the processed pressure data to an external data system.

7. The charge handle of claim 1, wherein at least one of the plurality of pressure sensors extends into the coolant flow path.

8. The charge handle of claim 1, further comprising a plurality of connectors secured to and extending from a distal end of the core, the plurality of connectors including fluid connectors to facilitate a flow of coolant between the charge handle and the electric aircraft.

9. The charge handle of claim 1, wherein at least one of the plurality of pressure sensors is mounted within a wall of the core.

10. A method to manage coolant flow in a charge handle for an electric aircraft, comprising:
detecting pressure within a coolant flow path in a core of the charge handle using a plurality of pressure sensors;
generating pressure data based on the detected pressure;
transmitting the pressure data from the plurality of pressure sensors as transmitted pressure data; and
enabling control of the coolant flow based on the transmitted pressure data.

11. The method of claim 10, wherein detecting pressure comprises detecting pressure at a plurality of locations within the coolant flow path.

12. The method of claim 10, wherein detecting pressure comprises detecting a first pressure in a coolant in chamber using a first pressure sensor of the plurality of pressure sensors and detecting a second pressure in a coolant out chamber using a second pressure sensor of the plurality of pressure sensors.

13. The method of claim 10, further comprising processing the pressure data using a printed circuit board assembly within the charge handle before transmission.

14. The method of claim 13, further comprising transmitting the processed pressure data to an external data system as the transmitted pressure data.

15. The method of claim 10 further comprises at least one of generating an alert based on the transmitted pressure data or detecting a blockage in coolant flow, based on the transmitted pressure data.

16. The method of claim 10, performing a reduction of the coolant flow based on the pressure data indicating the pressure of the coolant exceeds a threshold pressure.

17. A method of operating ground support equipment for an electric aircraft, the method comprising:
receiving, by the ground support equipment, coolant pressure data from a first pressure sensor and a second pressure sensor located within a charge handle coupled to the electric aircraft, wherein the first and second pressure sensors are configured to detect pressure within a coolant flow path in the charge handle; and
controlling, by the ground support equipment, coolant flow through the charge handle based on the received coolant pressure data.

18. The method of claim 17, wherein controlling the coolant flow comprises reducing the coolant flow based on the pressure data indicating that the coolant pressure exceeds a threshold pressure.

19. The method of claim 17, further comprising:
generating alerts based on the received pressure data based on the pressure data indicating conditions outside predetermined normal operating ranges; and
transmitting the generated alerts to an operator interface.

20. The method of claim 17, further comprising:
detecting blockages in the coolant flow path based on pressure differentials between the first pressure sensor and the second pressure sensor, using the coolant pressure data; and
adjusting the coolant flow in response to detecting the blockages.
